(19) United States
(12) Patent Application Publication
(10) Pub. No.: US 2024/0262058 A1
(43) Pub. Date: Aug. 8, 2024

(54) 3D SYSTEMS AND METHODS FOR PANCAKE LENS ARCHITECTURES

(71) Applicant: Meta Platforms Technologies, LLC, Menlo Park, CA (US)

(72) Inventors: Rongzhi Huang, Sammamish, WA (US); Nan Zhu, San Jose, CA (US); Jordy Rooijakkers, Eindhoven (NL); Daniel Puskas, Eindhoven (NL); Brent Bollman, Seattle, WA (US); Anqi Ji, Redwood City, CA (US); Jason Lozo, Lynnwood, WA (US); Alexander Sohn, Seattle, WA (US); Marvin Dion Alim, Duvall, WA (US); Sho Nakahara, Bothell, WA (US); Kurt Jenkins, Sammamish, WA (US); Keyuan Huang, Mountain View, CA (US); Fang Peng, San Jose, CA (US); Hanqing Zhao, Kirkland, WA (US); Yu Li, Bellevue, WA (US); Weiyao Li, Redmond, WA (US); Amir Ryan Zamiri, Sunnyvale, CA (US); Terence Johnson Lop Shie Chan, Cupertino, CA (US); Yoshitaka Sato, Yokohama (JP)

(21) Appl. No.: 18/396,356

(22) Filed: Dec. 26, 2023

Related U.S. Application Data
(60) Provisional application No. 63/483,132, filed on Feb. 3, 2023.
(60) Provisional application No. 63/485,022, filed on Feb. 15, 2023.
(60) Provisional application No. 63/486,356, filed on Feb. 22, 2023.

(51) Int. Cl. B29D 11/00; G02B 1/04; G02B 27/01

(52) U.S. Cl. CPC B29D 11/00403; B29D 11/00442; G02B 1/041; G02B 27/0172; G02B 2003/0093; G02B 2027/0178

(57) ABSTRACT

A method of manufacturing a meniscus lens includes providing an optical lens substrate having a non-planar deposition surface and depositing a resinous layer over the deposition surface to form the lens. Such a printed lens may have a radius of curvature of less than approximately 80 mm, sag of from approximately 2 mm to approximately 20 mm, a maximum thickness of less than approximately 40 mm, and a minimum thickness variation of at least approximately 2 mm.

### CROSS REFERENCE TO RELATED APPLICATION

This application claims priority to U.S. Application No. 63/483,132, filed 3 Feb. 2023, U.S. Application No. 63/485,022, filed 15 Feb. 2023, and U.S. Application No. 63/486,356, filed 22 Feb. 2023, the disclosures of each of which are incorporated, in their entirety, by this reference.

### BRIEF DESCRIPTION OF EXEMPLARY EMBODIMENTS

The accompanying drawings illustrate a number of exemplary embodiments and are a part of the specification. Together with the following description, these drawings demonstrate and explain various principles of the present disclosure.

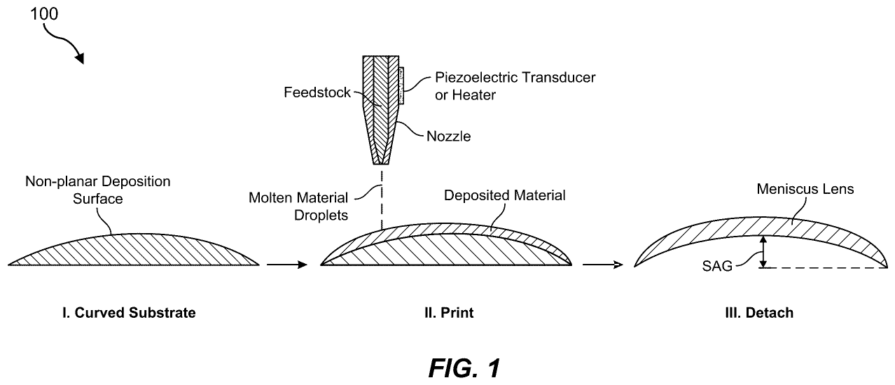

FIG. 1 is a schematic illustration of an example 3D printing method for forming a meniscus lens according to some embodiments.

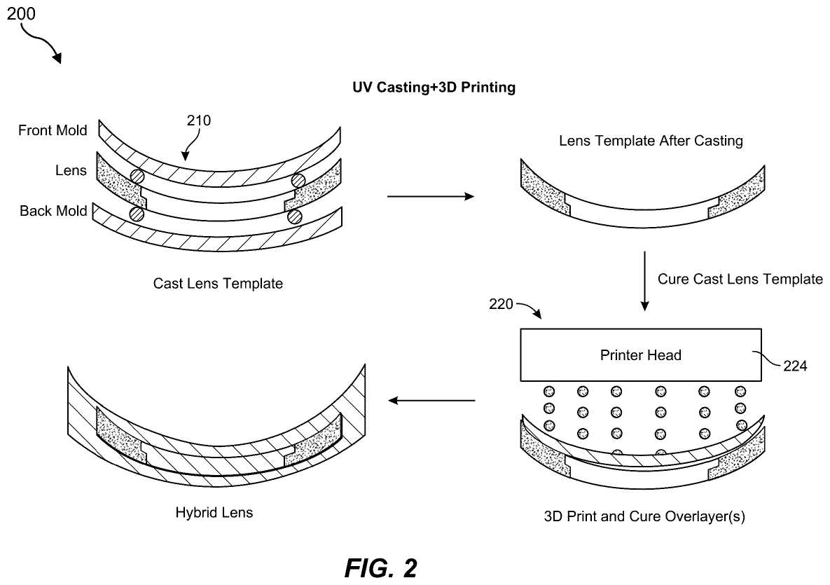

FIG. 2 is a schematic illustration of an example hybrid method for forming a cast/molded and over-printed meniscus lens according to some embodiments.

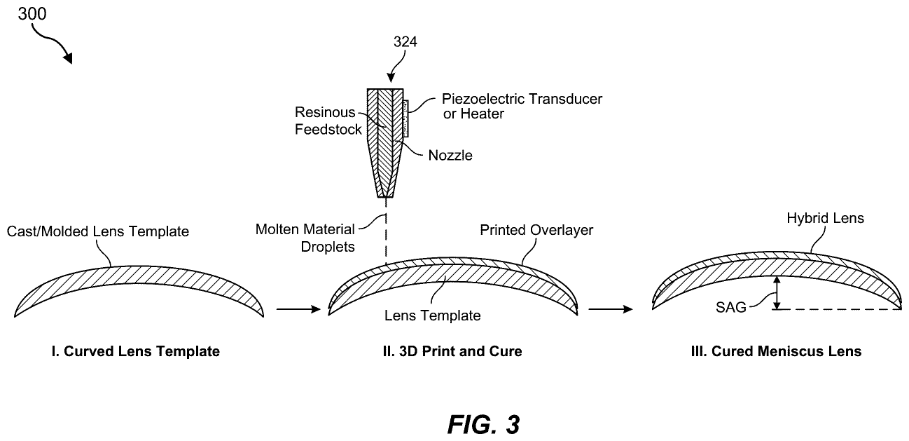

FIG. 3 is a schematic illustration of an example 3D printing process for forming a hybrid meniscus lens according to some embodiments.

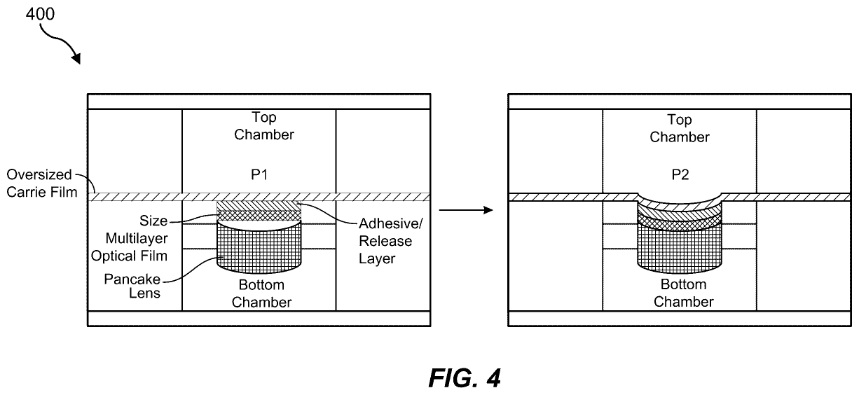

FIG. 4 is a schematic view of a lamination method and apparatus according to some embodiments.

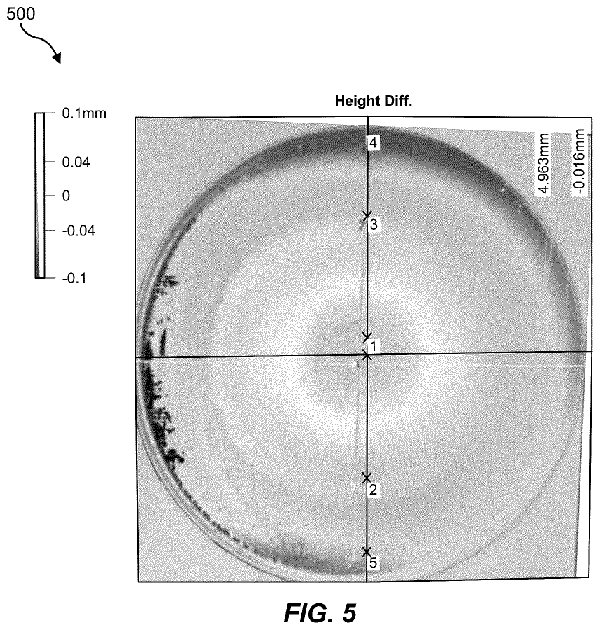

FIG. 5 shows an optical profile of a 3D printed meniscus lens according to certain embodiments.

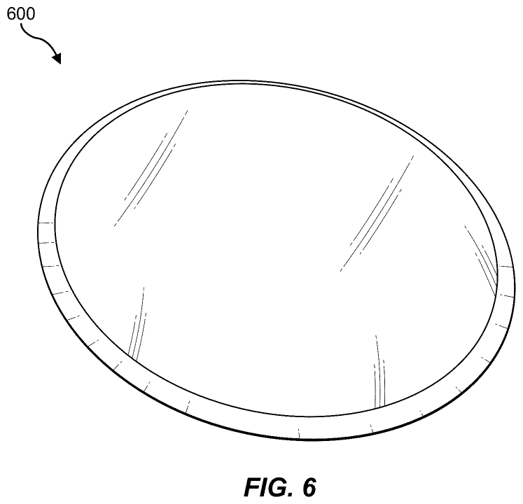

FIG. 6 is an optical micrograph of a 3D printed meniscus lens according to some embodiments.

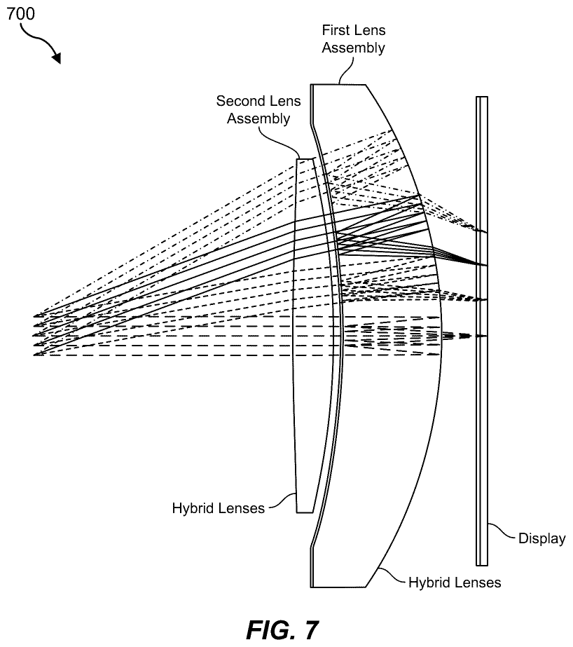

FIG. 7 is a cross-sectional schematic view of a pancake lens architecture according to certain embodiments.

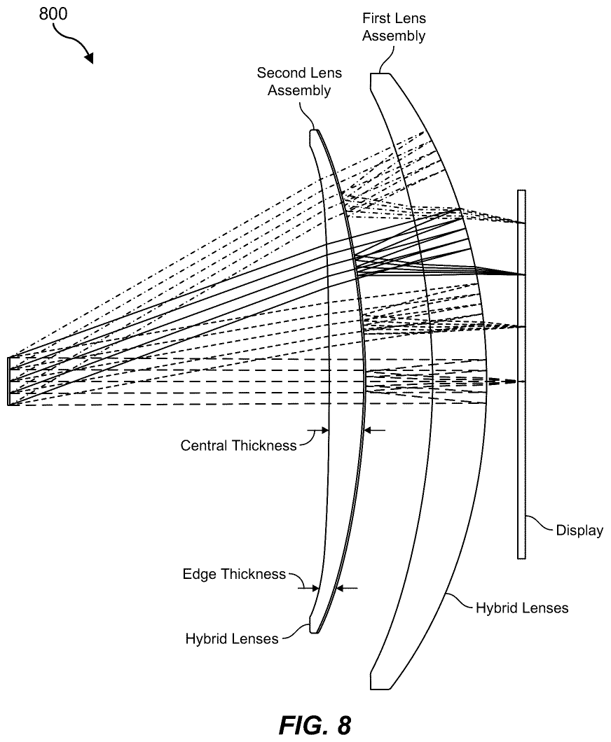

FIG. 8 is a cross-sectional schematic view of a pancake lens architecture according to further embodiments.

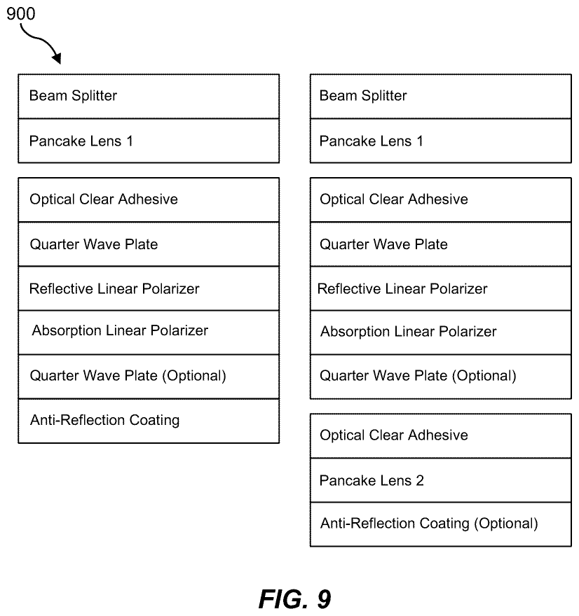

FIG. 9 is an illustration of example multilayer optical film architectures according to certain embodiments.

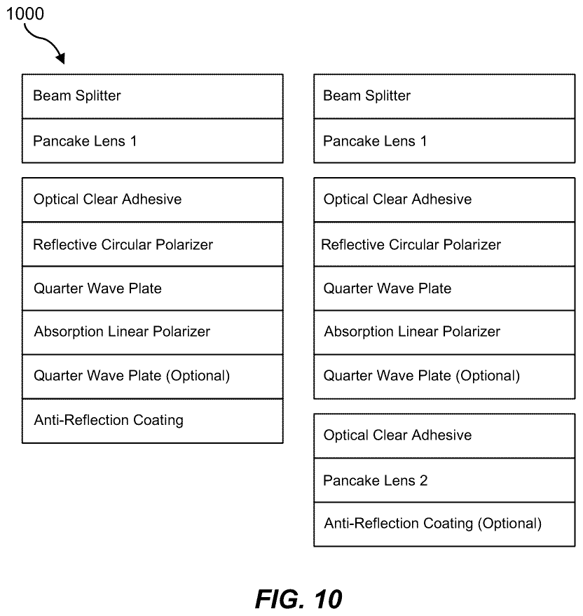

FIG. 10 is an illustration of example multilayer optical film architectures according to further embodiments.

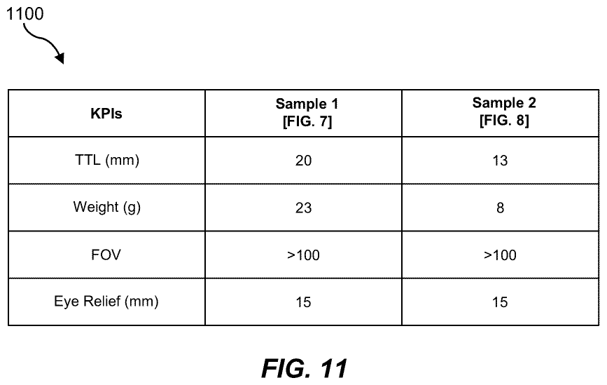

FIG. 11 is a summary of key performance indicators for the pancake lens architectures shown in FIGS. 7 and 8 according to various embodiments.

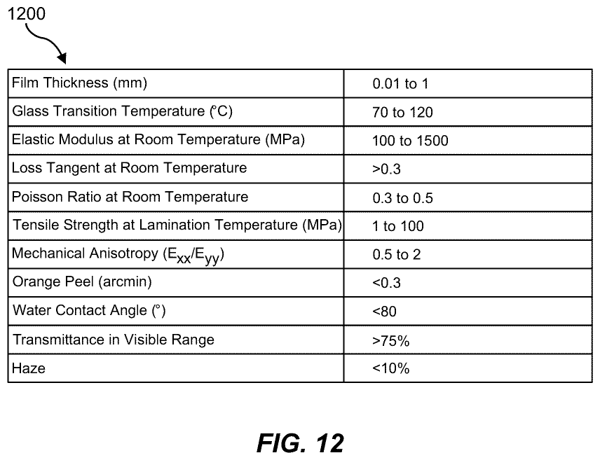

FIG. 12 is a table summarizing carrier film material specifications according to some embodiments.

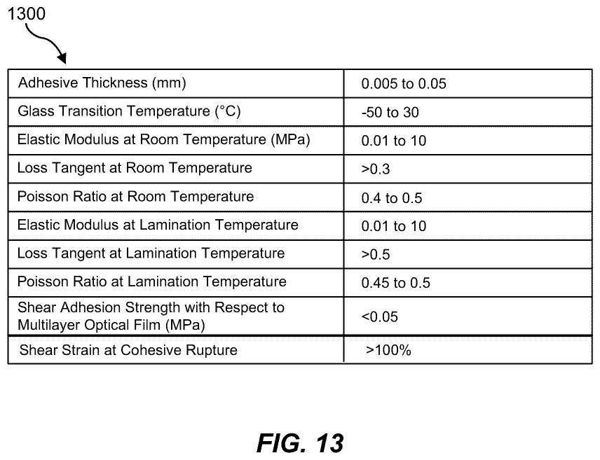

FIG. 13 is a table summarizing adhesive/release layer material specifications according to some embodiments.

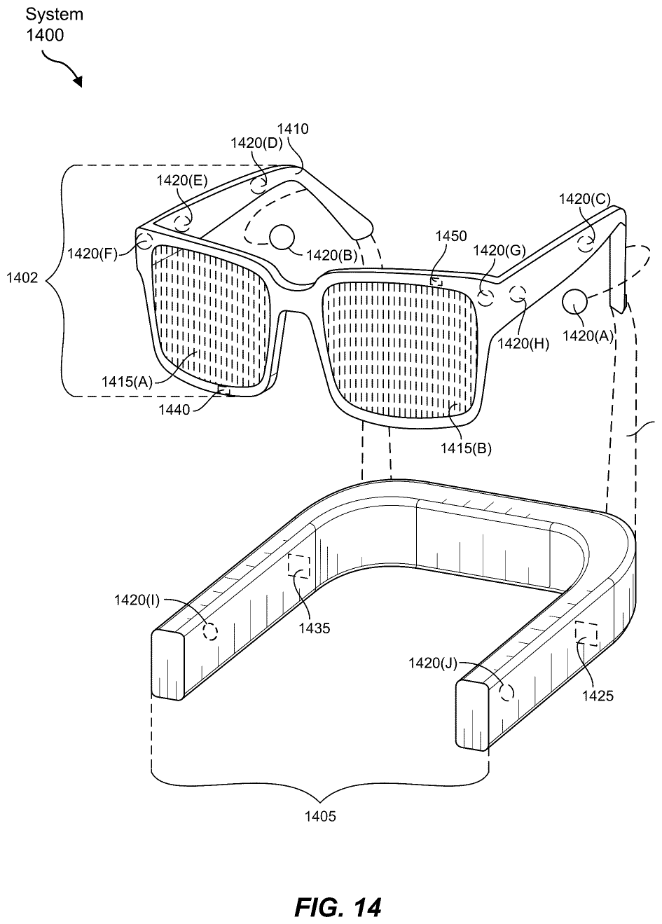

FIG. 14 is an illustration of exemplary augmented-reality glasses that may be used in connection with embodiments of this disclosure.

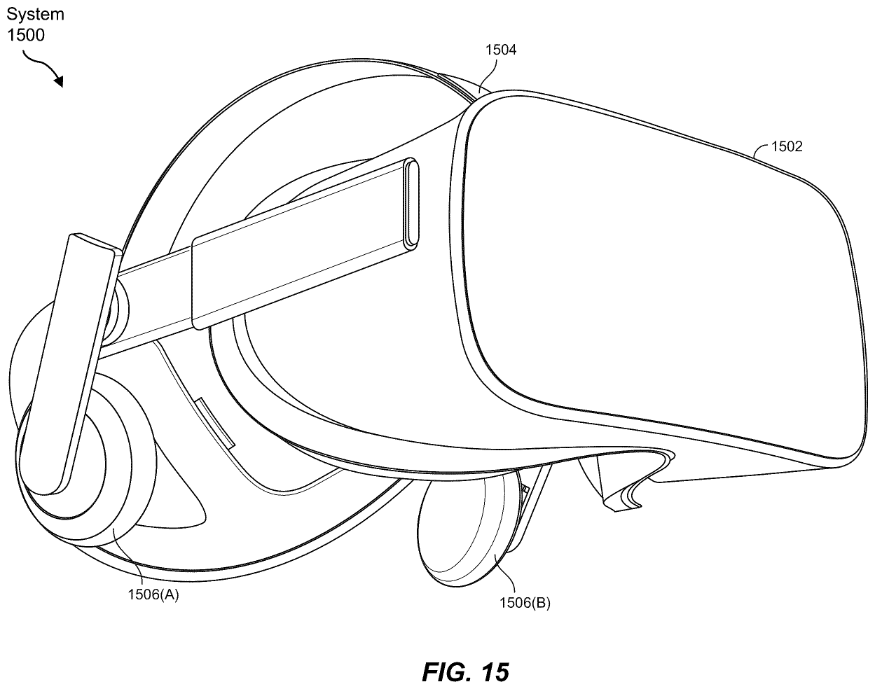

FIG. 15 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is directed generally to lens configurations for next-generation optical devices and optical systems, and more specifically to shell pancake lens architectures that may be configured to provide enhanced optical performance, including improvements in image quality and user experience. Also disclosed are 3D printing methods for manufacturing shell pancake lenses and associated structures. As is explained in greater detail herein, embodiments of the present disclosure include lens configurations suitable for virtual, mixed and/or augmented reality systems and devices. Example structures may be configured in an economical form factor and may include one or more printed meniscus pancake lenses having improved surface quality metrics.

Virtual reality (VR), mixed reality (MR), and augmented reality (AR) eyewear devices or headsets, for instance, may enable users to experience events, such as interactions with people in a computer-generated simulation of a three-dimensional world or viewing data superimposed on a real-world view. By way of example, superimposing information onto a field of view may be achieved through an optical head-mounted display (OHMD) or by using embedded wireless glasses with a transparent heads-up display (HUD) or augmented reality (AR) overlay. VR/MR/AR eyewear devices and headsets may be used for a variety of purposes. For example, governments may use such devices for military training, medical professionals may use such devices to simulate surgery, and engineers may use such devices as design visualization aids.

Pancake optics may be incorporated into virtual reality, mixed reality, and augmented reality systems and devices in order to provide a lightweight and compact form factor suitable for wearable operation. Notwithstanding recent developments, it would be advantageous to provide a more economical pancake optical configuration that includes a meniscus lens. Meniscus lenses are optical lenses that are configured to produce a smaller focal point and fewer aberrations than comparative plano-convex lenses. Meniscus lenses have one convex surface and one opposing concave surface with each surface having its own radius of curvature.

A positive meniscus lens has a larger radius of curvature on the concave side and a smaller radius of curvature on the convex side where the edges of such a lens are typically thicker than the center. A positive (or converging) meniscus lens can decrease the focal length of another lens while retaining angular resolution. For instance, positive meniscus lenses may be used to create a tighter beam focus.

A negative meniscus lens has a shorter radius of curvature on the concave side and a longer radius of curvature on the convex side such that the center of the lens is typically thinner than its edges. When used in combination with another lens, a negative (diverging) meniscus lens may be used to increase the focal length and decrease the numerical aperture (NA) of a lens configuration. Negative meniscus lenses may be useful for beam-expanding applications, which require minimal spherical aberration.

In accordance with various embodiments, a 3D printing technology may be used to manufacture meniscus lenses that are thin, lightweight, and have smooth surfaces that advantageously derive from a suite of surface characteristics, including primary profile (P), roughness profile (R), and waviness profile (W), which are related to image quality metrics such as pupil swim and image distortion. Printed meniscus lenses may have a large thickness variation and aspect ratio, for example, which may be challenging to manufacture using comparative methods such as injection molding.

As disclosed herein, a method of manufacturing a meniscus lens may include discrete casting/molding and printing operations. Such a hybrid approach may substantially decrease cycle time and manufacturing costs, where a casting or molding paradigm may be used to form the majority of the lens volume and 3D printing may be used subsequently to deposit an overlayer that tunes the optical properties of the lens.

An example hybrid method includes introducing a first resin composition into a mold, curing the first resin composition to form a lens template, depositing a layer of a second resin composition over a surface of the lens template to form a modified lens template, and curing the layer of the second resin composition to form a hybrid lens. Compositionally identical or distinct resin compositions may be used for the respective casting/molding and printing operations. Identical or substantially identical resins may mitigate issues associated with mismatched refractive indices and/or coefficients of thermal expansion, including bubble formation, delamination, or other reliability issues.

A suitable casting apparatus may include a diamond-turned glass mold into which a suitable resin may be poured or injected. Suitable 3D printing apparatus may include a pixel type printer head where the output droplet size may be precisely controlled. An average droplet size may be on the order of a few micrometers. In an example method, a polymeric meniscus lens may be built up by printing onto a cast or molded lens template. As will be appreciated, cast/molded and over-printed lenses may be thinner and substantially lighter weight than comparable lenses manufactured by molding or casting operations. Moreover, 3D printing may be configured to change the cylindrical optical power of a lens template, i.e., along different axes. Such a meniscus lens may be challenging to manufacturing using casting or molding processes alone.

In some embodiments, a cast/molded lens template may cured, e.g., thermally or UV cured, to stabilize the lens prior to subsequent printing. Moreover, the act of printing may include depositing one or more successive layers each followed by a respective curing step, i.e., prior to printing a subsequent layer.

Suitable 3D printing apparatus may include a pixel type printer head where the output droplet size may be precisely controlled. In an example method, a polymeric meniscus lens may be built up by printing onto a suitably curved substrate, such as a concave or convex substrate. As will be appreciated, 3D-printed lenses may be thinner and substantially lighter weight than comparable lenses manufactured by molding or casting operations. For example, 3D printed polymeric meniscus lenses may be at least approximately 25% thinner and 50% lighter than injection molded lenses. In some embodiments, a printed meniscus lens may have at least one surface (e.g., two surfaces) with a radius of curvature of less than approximately 80 mm, e.g., less than 80 mm, less than 70 mm, less than 60 mm, less than 50 mm, less than 40 mm, or less than 30 mm, including ranges between any of the foregoing values. A maximum thickness of a printed meniscus lens may be less than approximately 40 mm, e.g., less than 40, 30, 20, or 10 mm, including ranges between any of the foregoing values. Moreover, a printed meniscus lens may exhibit a large thickness variability from its center to its edge. In example structures, a difference in center to edge thickness may be at least approximately 2 mm, e.g., 2, 4, 6, 8, 10, 15, 20, 25, 30, or 35 mm, including ranges between any of the foregoing. In addition, the sag of a printed meniscus lens may range from approximately 2 mm to approximately 20 mm, e.g., 2, 4, 6, 8, 10, or 20 mm, including ranges between any of the foregoing values. In some examples, the sag may be used to describe the distance or length between the vertex point along the curve and the center point of a line drawn perpendicular to the curve from one edge to the other.

Pancake lenses may be cast or printed from a UV curable resin where an over-formed multilayer optical film may be provided to tune the optical properties of the lens. A multilayer optical film may be laminated to a surface of a lens substrate, including a non-planar lens substrate. For example, a non-planar lens may have a desired degree of spheroidicity and/or cylindricity. In turn, a laminated multilayer optical film may be configured to introduce one or more optical functionalities, such as polarization, retardation, antireflection, diffraction, etc.

In an example method, materials utilization may be improved and the propensity for lamination-induced defects may be decreased by appropriately sizing a multilayer optical film to the dimensions of a curved substrate and mounting the multilayer optical film to a more economical but oversized carrier film. Accordingly, a lamination architecture may include a carrier film and a multilayer optical film overlying an interior portion of the carrier film. A related method may include forming a lamination architecture and forming a laminated pancake optic by contacting a surface of the multilayer optical film with a surface of a transparent non-planar substrate.

In some examples, the lamination architecture may include an adhesive/release layer located between the carrier film and the multilayer optical film. The adhesive/release layer may be configured to have strong adhesion to the carrier film but weak peel adhesion with respect to the multilayer optical film. Following lamination, the adhesive/release layer and the oversized carrier film may be separated from the surface-modified lens. Example carrier films may include poly (methyl methacrylate) (PMMA) or a polyolefin polymer. The adhesive/release layer may include a UV-curable acrylate adhesive, for example.

A pancake lens may demonstrate a controlled refractive index, high transmissivity, and low bulk haze. In some embodiments, a meniscus lens may exhibit a high degree of optical clarity and bulk haze of less than approximately 10%. In particular examples, a meniscus lens may be characterized by a refractive index of from approximately 1.45 to approximately 1.6, e.g., 1.45, 1.5, 1.55, or 1.6, including ranges between any of the foregoing values, a transmissivity within the visible light spectrum of at least approximately 90%, e.g., 90, 92, 95, 97, 98, 99, or 99.5%, including ranges between any of the foregoing values, and less than approximately 10% bulk haze, e.g., 0, 1, 2, 4, 6, or 8% bulk haze, including ranges between any of the foregoing values.

Meniscus lenses may be printed from a UV curable resin and may demonstrate a controlled refractive index, high transmissivity, and low bulk haze. In some embodiments, a printed polymeric meniscus lens may exhibit a high degree of optical clarity and bulk haze of less than approximately 10%. In particular examples, a 3D printed meniscus lens may be characterized by a refractive index of from approximately 1.45 to approximately 1.6, e.g., 1.45, 1.5, 1.55, or 1.6, including ranges between any of the foregoing values, a transmissivity within the visible light spectrum of at least approximately 90%, e.g., 90, 92, 95, 97, 98, 99, or 99.5%, including ranges between any of the foregoing values, and less than approximately 10% bulk haze, e.g., 0, 1, 2, 4, 6, or 8% bulk haze, including ranges between any of the foregoing values.

As used herein, the terms “haze” and “clarity” may refer to an optical phenomenon associated with the transmission of light through a material, and may be attributed, for example, to the refraction of light within the material, e.g., due to secondary phases or porosity and/or the reflection of light from one or more surfaces of the material. As will be appreciated by those skilled in the art, haze may be associated with an amount of light that is subject to wide angle scattering (i.e., at an angle greater than 2.5° from normal) and a corresponding loss of transmissive contrast, whereas clarity may relate to an amount of light that is subject to narrow angle scattering (i.e., at an angle less than 2.5° from normal) and an attendant loss of optical sharpness or “see through quality.”

Optical configurations including one or more pancake lenses may be used in various applications, such as AR/VR systems, cameras, projection apparatus and other optical systems. Certain applications may require accommodation during operation and hence may incorporate one or more actuators that are configured to change the focal length of the optical configuration. In many cases, the rate of focal length change may be fast, for example, less than 1 second, or even less than 200 ms. Examples may provide one or more of such features where, for example, the response time of the actuators may be on the order of milliseconds or less. In some examples, the change in focal length provided by the actuator may range from 1 diopter to over 5 diopters, and variable cylinder and axis may be provided using appropriate electrical signals provided to the actuator. For example, a controller may determine a desired image distance from the eye of a user (e.g., measured from the front of the cornea or from a display), determine electrical signals to provide a desired focal length of the adjustable lens, and provide the appropriate electrical signals to the actuator to obtain, for example, a curved surface appropriate for the desired image distance.

Compact optical systems may be useful for head-mounted displays, including virtual and augmented reality apparatus. Varifocal operation may be useful for user comfort and experience. A varifocal lens may be an edge-driven lens, where the curvature is, for example, controlled by an actuator located near the edge of the lens, where the actuator may apply a bending force that controls the curvature of the lens. Substantial force may be required for this mode of operation, and the actuator motion may be complicated, possibly increasing space and power requirements and increasing both the actuator and lens weight. Further, adding actuators to the optical configuration may cause stray light issues. However, in some examples, stray light may be reduced by maintaining a high degree of light polarization. In this context, a high degree of light polarization may correspond to a polarization ratio of at least approximately 10:1, such as at least approximately 20:1.

Examples include optical configurations including at least one lens having variable accommodation. Examples include relatively compact lenses (e.g., compared to lenses having edge-driven actuators), lenses with a wide accommodation range, and lenses with cylinder adjustment. In some examples, an optical configuration including at least one varifocal lens having an optical power that may be adjusted using a controller may provide prescription lens correction for a user (e.g., for real world images) and/or may allow adjustment of the eye accommodation appropriate for a user to view an augmented or virtual image element.

In some examples, an apparatus may include a first lens assembly including a first lens, a reflector, and an actuator layer. The first lens may include a 3D printed meniscus lens. The reflector may include a polarizing reflector, beam splitter or other reflector. An apparatus may further include a second lens assembly including a second lens and a second reflector, such as a polarizing reflector, beam splitter, or other reflector. In some examples, the second lens assembly may include a second lens, a second reflector (e.g., a beam splitter or reflective polarizer). The second lens may include a 3D printed meniscus lens. In some examples, the second lens may include a reflector and an absorbing polarizer. For example, the second reflector may provide an approximately 50/50 (reflected %/transmitted %) beam splitter. However, this ratio is not limiting and the reflected intensity percentage may range from approximately 30% to 70%, with the transmitted percentage correspondingly ranging from approximately 70% to 30%, neglecting absorption losses.

In some examples, a reflector may include a beam splitter. In some examples, a beam splitter may include a thin metal coating, where the metal may include silver, gold, aluminum, other metal (e.g., other transition metal or non-transition metal), or any combination of metals such as an alloy. In some examples, the beamsplitter may include a dielectric layer, a dielectric multilayer, or polymer, such as a polymer layer having a silver appearance. For example, the beam splitter may include a dielectric single or multiple layer, or a combination of any approaches or materials described herein (e.g., a combination of one or more metal layers, dielectric layers, and/or other layers).

In some examples, an apparatus includes a first lens assembly including a first reflective layer and a second lens assembly including a reflective layer and a third layer (e.g., an actuator layer).

Regarding the second lens assembly, the reflective layer may include a reflective polarizer. In some examples, an absorbing polarizer layer may be adjacent and between the reflective layer and the third layer, and the polarization axis of the absorbing polarizer layer may be parallel to the polarization axis of the reflective layer. The reflective layer may be an approximately 50/50 beam splitter. The beam splitter may include a thin metal coating on a substrate, such as a silver layer or aluminum layer on a glass or polymer substrate. The beam splitter may include a single dielectric layer or a multilayer structure such as a dielectric multilayer. In some examples, a beamsplitter may include a combination of one or more metal layers and one or more dielectric layers.

In some examples, the first lens assembly and/or the second lens assembly may each include at least one Fresnel lens. A Fresnel lens may include a 3D printed lens. In some examples, a reflector may include a layer coated on the surface of a Fresnel lens. For example, a reflective polarizer may be supported on a planar or faceted surface of a Fresnel lens.

In some examples, a method of controlling the apparent distance of an image for a user includes determining the desired viewing distance of an image and applying a voltage to a transparent actuator in at least one lens making up the pancake lens to control the curvature of the lens. In some examples, the control of the curvature of the lens may use an open loop system. In some examples, a controller may provide at least one electrical signal to corresponding (at least one) pair of electrodes to independently control a plurality of actuator layers.

In some examples, the control of the curvature of the lens may use a closed loop feedback system where the curvature or a parameter based on the curvature (e.g., optical power) may be determined by a sensor (e.g., a capacitance sensor or an optical sensor such as an image and/or focus sensor). For example, a sensor may determine the curvature of the lens, and the voltage is controlled or adjusted based on the sensor measurement.

In some examples, a controlled birefringence actuator includes a first actuator layer and at least a second actuator layer, where the first and second actuator layers have a high refractive index axis, and the orientation of the first and second layer are perpendicular to each other. For example, each actuator layer may be birefringent and have an optic axis parallel to the plane of the layer. For curved actuator layers, the local optic axis may be within the local plane of the layer. An actuator may include (e.g., have only) two actuator layers, where the optic axes of the pair of layers may be orthogonal to each other and may both be within the plane of the respective layer.

In some examples, an actuator may include a stack of 3 or more actuator layers, where the orientation of each layer is clocked. In this context, clocked orientations may refer to actuator layers in which the optic axis (and/or direction of maximum actuation) for each layer may have an angular offset from that of an adjacent or neighboring layer. For example, the optic axes of a plurality of layers may rotate in angular increments around a direction generally orthogonal to the layers. The optic axes may generally describe a stepped spiral around the direction generally orthogonal to the layers. In some examples, an actuator may include at least 5 actuator layers and the orientation of each layer is clocked.

In some examples, at least one lens assembly may include an active lens, such as a lens assembly including an actuator layer that is transparent and can be electronically energized causing a change in the curvature of the lens. In some examples, the optical configuration may be described as a pancake lens, for example, an imaging lens having first and second partially reflective and partially transparent lens surfaces, where one of the surfaces may be a partial reflector, and the other surface may be a reflective polarizer.

Examples include a lens assembly including an actuator. In some examples, an actuator may include a unimorph and/or a bimorph actuator. A unimorph actuator may include an electroactive layer where applying an electric field to the electroactive layer creates a mechanical force in the plane of the electroactive layer, and a passive layer such as a polymer film, such as an acrylate polymer film such as PMMA (polymethylmethacrylate).

A bimorph actuator may include a first electroactive layer bonded to a second electroactive layer, optionally with a passive layer located between the first and second electroactive layers. In some examples, an actuator may have a multilayer structure and the orientation of the layers may be clocked. In this context, clocked layers may refer to the direction of highest refractive index being rotated in an approximately uniform degree between neighboring actuator layers. For example, a 3 layer stack may have the orientation of the first, second, and third layers oriented (e.g., in plane) at 0°, 60°, and 120°. In some examples, the angular offset (e.g., in-plane angular offset) between successive birefringent layers (e.g., neighboring or adjacent layers, progressing through the stack) may be 360/N degrees, where N is the number of actuator layers in the actuator or a portion thereof.

In some examples, an AR/VR device may include a display and a lens with variable accommodation. The lens may be a pancake lens that folds the light path back on itself to reduce the device dimensions. The device may include a display and a liquid lens having a transparent actuator layer that may be configured to control the optical power of the lens. The device may also include a beamsplitter and a polarized reflector. The actuator layer may include at least one birefringent layer (having different refractive indices in different directions, e.g., different directions within the plane of the layer) and this may cause unwanted optical effects if the display emits polarized light. In some approaches, these effects may be avoided using a display that emits unpolarized light and polarizing the light after it passes through the actuator layer.

In some approaches, linearly polarized light from a display may be aligned with an optical axis of the actuator layer and an optical retarder may be used to compensate for any unwanted optical effects. In further approaches, multiple actuator layers may be stacked and arranged so that the exit light has the same polarization as the input light. For example, birefringent layers may have a clocked multilayer arrangement in which the optic axis rotates around 360 degrees through a plurality of stepped changes in direction, where the angular step between neighboring layers may be at least 10 degrees and may be (at least approximately) equal steps. In some examples, actuators may include polymers with low birefringence that may greatly reduce unwanted optical effects. In some examples, devices may also include an optically absorbing layer to reduce reflections from the user's eye entering the optical system. For example, a lens assembly (e.g., a lens assembly closer to the user's eye) may include an absorbing polarizer.

In some examples, a method may include emitting light (e.g., including one or more light rays) from a display, transmitting the light through a first lens assembly, reflecting the light from a second lens assembly, and reflecting the light from the first lens assembly through the second lens assembly and towards an eyebox, for example, where a user may view an image of the display when the user wears the device. One or both lens assemblies may include a Fresnel lens. One or both lens assemblies may include an adjustable lens. One or both assemblies may include a 3D printed meniscus lens. The eye of a user may be located at the eyebox (e.g., a location of display image formation) for viewing the image of the display. The first lens assembly may include a first lens and a first reflective polarizer. The second lens assembly may include a second lens and a second reflective polarizer. In some examples, a method may further include adjusting at least one optical parameter (e.g., optical power and/or cylindricity) of at least one lens assembly.

In some examples, an optical retarder may be located between the first and second lens assemblies, and the light from the display may pass through the optical retarder on a plurality of occasions (e.g., three times) before being transmitted through the second lens assembly towards the eye of the user. In some examples, light may be emitted from the display with a polarization, such as a linear polarization or a circular polarization. The polarization may be modified by the optical retarder each time the light passes through the optical retarder.

Reflections may also modify the polarization of light. For example, light (e.g., polarized light) from the display may be transmitted through the first lens assembly, pass through the optical retarder, be reflected by the second lens assembly, pass through the optical retarder, be reflected by the first lens assembly, pass through the optical retarder, and then be transmitted by the second lens assembly towards the eye of a user, where the light may be incident on the reflective polarizer with a first linear polarization, which may be reflected by the reflective polarizer of the second lens assembly. Light may reflect from the reflective polarizer of the first lens assembly and may then be transmitted by the reflective polarizer. In some examples, at least one of the lens assemblies may include an optical retarder and the separate optical retarder may be omitted from the optical configuration. In some examples, a method may further include adjusting at least one optical parameter (e.g., optical power and/or cylindricity) of at least one lens assembly.

In some examples, the image brightness provided by the display (e.g., including a display panel) using an optical configuration may include spatially adjusting the spatial profile of the illumination brightness of a light source (e.g., a backlight) and/or an emissive display. Display brightness may be adjusted as a function of one or more display parameters, such as spatial position on the display (e.g., spatial variations in image brightness), power consumption, aging effects, eye response functions, and/or other parameter(s).

In some examples, a method may include emitting light having circular or linear polarization from a display, transmitting the light through a first lens assembly, reflecting the light from a second lens assembly, and reflecting the light from the first lens assembly through the second lens assembly and towards an eye of a user. The apparatus may be configured so that the light is transmitted through the first lens assembly having a first polarization and reflected by the first lens assembly having a second polarization. This may be achieved using an optical retarder located between the first and second lens assemblies and/or using changes in polarization upon reflection. A display may inherently emit polarized light or, in some examples, a suitable polarizer may be associated with (e.g., attached to) a surface through which light from the display is transmitted. In some examples, a method may further include adjusting at least one optical parameter (e.g., optical power and/or cylindricity) of at least one lens assembly.

Example methods include computer-implemented methods for operating an apparatus, such as an apparatus as described herein such as a head-mounted display or an apparatus for fabricating a lens assembly. The steps of an example method may be performed by any suitable computer-executable code and/or computing system, including an apparatus such as an augmented reality, mixed reality and/or virtual reality system. In some examples, one or more of the steps of an example method may represent an algorithm whose structure includes and/or may be represented by multiple sub-steps. In some examples, a method for providing uniform image brightness from a display using a folded optic configuration may include using a display panel that is configured to allow a spatial variation of the display brightness. In this context, light from a display may be reflected at least once (e.g., twice) within a folded optic configuration before reaching the eye of a user. In some examples, a method may further include adjusting at least one optical parameter (e.g., optical power and/or cylindricity) of at least one lens assembly.

In some examples, an apparatus, such as a head-mounted device or system, may include at least one physical processor and physical memory including computer-executable instructions that, when executed by the physical processor, cause the physical processor to generate an image on the display. The image may include a virtual reality image element and/or an augmented reality image element. The apparatus may include an optical configuration such as described herein. A controller may include the at least one physical processor. The controller may be configured to adjust at least one optical parameter (e.g., optical power and/or cylindricity) of at least one lens assembly. A head-mounted device may be an augmented reality device, a mixed reality device, a virtual reality device, or other device.

In some examples, a non-transitory computer-readable medium may include one or more computer-executable instructions that, when executed by at least one processor of an apparatus (e.g., a head-mounted device), cause the apparatus to provide an augmented reality image or a virtual reality image to the user (e.g., the wearer of the head-mounted device). The apparatus may include an optical configuration such as described herein. A controller may include the at least one physical processor. The controller may be configured to adjust at least one optical parameter (e.g., optical power and/or cylindricity) of at least one lens assembly, for example, by adjusting at least one electrical signal applied to a multilayer actuator through which light used to provide an augmented reality image element passes.

In some examples, an apparatus (e.g., a head-mounted device such as an AR and/or VR device) may include an optical configuration including a pancake lens (e.g., a combination of a lens and a beamsplitter, which may also be termed a beamsplitter lens) and a reflective polarizer. The pancake lens may include a 3D printed meniscus lens.

The optical configuration may be termed a folded optic configuration, and in this context, a folded optic configuration may provide a light path that includes one or more reflections and/or other beam redirections. An apparatus having a folded optic configuration may be compact, have a wide field-of-view (FOV), and allow formation of high-resolution images. Higher lens system efficiency may be useful for applications such as head-mounted displays (HMDs), including virtual reality, mixed reality and/or augmented reality applications.

An example apparatus may include a display, a pancake lens (e.g., including a beamsplitter or polarized reflector that may be formed as a coating on a lens surface), and a reflective polarizer (e.g., configured to reflect a first polarization of light and transmit a second polarization of light, where the first polarization and second polarization are different). For example, a reflective polarizer may be configured to reflect one handedness of circularly polarized light and transmit the other handedness of circularly polarized light.

An example apparatus, such as a head-mounted device, may include a lens assembly including a lens and a reflective polarizer. An example lens may include a 3D printed meniscus lens. An example reflective polarizer may be configured to reflect one polarization of light and transmit another polarization of light. For example, an example reflective polarizer may reflect one handedness of circularly polarized light and may transmit the other handedness of circularly polarized light. A further example reflective polarizer may reflect one linear polarization direction and transmit an orthogonal linear polarization direction. An example apparatus may include a display, and the display may be configured to emit polarized light. In some examples, an apparatus may be an augmented reality and/or virtual reality (AR/VR) headset.

In some examples, an apparatus may include a display and an optical configuration. The optical configuration may include a first lens assembly and a second lens assembly. The first lens assembly may include a lens, such as a fluid lens (e.g., a liquid lens) and/or a Fresnel lens. The lens within the first lens assembly may be a 3D printed meniscus lens. The first lens assembly may include a reflective polarizer or a beamsplitter. An example reflective polarizer may be configured to reflect a first polarization and transmit a second polarization of incident light. The optical configuration may form an image of the display viewable by a user when the user wears the apparatus, and the image may provide an augmented reality image to the user.

Folded optic configurations (e.g., including one or more reflective elements such as beamsplitters and/or reflective polarizers) may be compact, have a wide field-of-view (FOV), and provide higher resolution for a given distance between the display and a viewer. Additionally, it may be valuable to adjust an eye focus distance (e.g., a visual accommodation) to an augmented reality image element to obtain a desired visual accommodation in the eye of the user. In some examples, the visual accommodation for a viewed image may be adjusted to at least approximately match an image distance corresponding to the user eye vergence used to view the provided left and right eye images. In this context, vergence may relate to an apparent distance to an image based on convergence of the viewing directions of left and right eyes, and visual accommodation (or, more concisely, accommodation) may refer to an apparent distance to the image based on the focal length of the eye. Visual accommodation may be adjusted by adjusting the optical power of at least one lens.

In some examples, the optical configuration may also provide a prescription lens adjustment of a real world image, for example, including corrections for optical power, cylinder and/or astigmatism. In some examples, a lens assembly may include a lens, such as a Fresnel lens, fluid lens or other refractive lens, and a beamsplitter and/or polarizing reflector.

In some examples, an apparatus component such as a lens or other optical element may include one or more optical materials. An example optical material may be selected to provide low birefringence (e.g., less than one quarter wavelength optical retardance, such as less than approximately [symbol] /10, for example, less than approximately [symbol] /20). In some examples, a Fresnel lens and/or filler polymer (and/or other optical element) may include a silicone polymer such as polydimethylsiloxane (PDMS), cyclic olefin polymer (COP), cyclic olefin copolymer (COC), polyacrylate, polyurethane, polycarbonate, or other polymer. For example, a silicone polymer (e.g., PDMS) lens may be supported on a rigid substrate such as glass or a polymer (e.g., a relatively rigid polymer compared with the silicone polymer). In some examples, the optical power of a silicone polymer lens having at least one curved surface may be adjusted using an actuator, such as a multilayer actuator.

In some examples, a component of an optical configuration may include one or more optical materials. For example, an optical material may include glass or an optical plastic. An optical material may be generally transmissive over some or all of the visible spectrum. In some examples, an optical component including a generally transmissive material may have an optical transmissivity of greater than 0.9 over some or all of the visible spectrum and may be termed optically transparent.

In some examples, a substrate (e.g., for a reflector), an optical material, and/or a layer (e.g., of an optical component) may include one or more of the following: an oxide (e.g., silica, alumina, titania, other metal oxide such as a transition metal oxide, or other non-metal oxide), a semiconductor (e.g., an intrinsic or doped semiconductor such as silicon (e.g., amorphous or crystalline silicon), carbon, germanium, a pnictide semiconductor, a chalcogenide semiconductor, or the like), a nitride (e.g., silicon nitride, boron nitride, or other nitride including nitride semiconductors), a carbide (e.g., silicon carbide), an oxynitride (e.g., silicon oxynitride), a polymer (e.g., a UV curable polymer), a glass (e.g., a silicate glass such as a borosilicate glass, a fluoride glass, or other glass), or other material.

Example reflective polarizers may include, without limitation, cholesteric reflective polarizers (CLCs) and/or multilayer birefringent reflective polarizers. These and other examples are discussed in more detail below. A reflective polarizer may include a wire grid, a multilayer birefringent polymer, or a cholesteric reflective polarizer. In this context, a cholesteric reflective polarizer may have optical properties similar to (and in some examples, derived from) a cholesteric liquid crystal. A cholesteric reflective polymer may include a solid (e.g., have at least one solid component), such as a polymer (e.g., a cross-linked polymer), a polymer stabilized material or a polymer-dispersed material.

In some examples, a reflective polarizer may be fabricated by applying an alignment layer (e.g., a polymer layer or grating) and applying at least one layer of a cholesteric liquid crystal (CLC) which is at least partially aligned to the alignment layer. The alignment layer may include a photoalignment material (PAM) that may be deposited over a substrate, and a desired molecular orientation may be obtained by exposing the PAM to polarized light (such as ultraviolet (UV) and/or visible light). A CLC may be further processed to lock the molecular alignment of a CLC within a solid material, for example, to provide a chiral material such as a chiral solid. A CLC may be polymerized, cross-linked, and or a polymer network may be formed through the CLC to stabilize the alignment to provide a chiral solid. A chiral solid may be referred to as a CLC-based material if a CLC phase was used in its preparation. In some examples, a CLC may be formed using an effective concentration of chiral dopant within a nematic liquid crystal, and the chiral nematic (cholesteric) mixture may further include polymerizable materials.

In some examples, a reflective polarizer may include a chiral material such as a material having molecular ordering similar to that of a cholesteric liquid crystal, such as a solid material derived from cooling, polymerizing, cross-linking, or otherwise stabilizing the molecular order of a cholesteric liquid crystal. For example, a chiral solid may be a solid having a helical optical structure similar to that of a cholesteric liquid crystal. For example, a direction of maximum refractive index may describe a helix around a normal to the local direction of molecular orientation.

Examples may include an apparatus having a folded optic configuration, such as an apparatus including one or more lenses, such as a pair of lens assemblies. Example optical configurations may allow an increased optical efficiency of an optical configuration, for example, by reducing losses associated with beamsplitters. Increased optical efficiency may provide one or more of the following aspects: improved image appearance (e.g., improved image brightness, uniformity and/or resolution), increased lens efficiency, reduced power consumption, and/or reduced heat generation for a given brightness. Examples also include associated methods, such as methods of fabrication of improved lens assemblies, methods of fabricating devices including one or more actuators and/or lens assemblies, or methods of device use.

In some examples, a reflective polarizer may include a birefringent multilayer optical film that may be conformed to a surface (e.g., the faceted substrate of a Fresnel lens or a membrane surface of an adjustable fluid lens) through a combination of heat and pressure.

In some examples, the reflective polarizer may include a cholesteric liquid crystal, a birefringent multilayer optical film, or a wire grid. In some examples, a reflective polarizer may include an arrangement of electrically conductive elements, such as wires, rods, tubes, or other conductive elements. Electrically conductive elements may include at least one metal (e.g., copper, gold, silver, or other metal or alloy thereof), electrically conductive carbon allotrope, doped semiconductor, or the like. In some examples, a reflective polarizer may include a birefringent multilayer film, and the skin layer or layers may have a pass polarization refractive index that is within approximately 0.2 of the average refractive index of the multilayer film, and in some examples, a refractive index that differs from the average refractive index of the multilayer film by at least approximately 0.02, such as at least approximately 0.05, for example, at least approximately 0.1.

In some examples, a reflective polarizer may include a multilayer assembly including at least one optically isotropic layer adjacent to (e.g., alternating with) a birefringent (e.g., uniaxial) polymer layer. Layers may be generally parallel and may conform to an underlying optical element that may act as a substrate. An optically isotropic polymer layer may include an optically transparent polymer. A birefringent polymer layer may include an anisotropic polymer layer, such as a stretched or otherwise at least partially molecularly aligned polymer layer. For example, a polymer layer may be stretched by a factor of between 1.5 and 10 (e.g., stretched by a ratio of between 1.5:1 and 10:1, where the ratio represents a ratio of a final extent along a particular direction to an initial extent).

An example reflective polarizer may be configured to reflect a first polarization of light and transmit a second polarization of light. For example, a reflective polarizer may be configured to reflect one handedness of circularly polarized light (e.g., right or left) and transmit the other handedness of circularly polarized light (e.g., left or right, respectively). In further examples, a reflective polarizer may be configured to reflect one direction of linearly polarized light (e.g., vertical) and transmit an orthogonal direction of linearly polarized light (e.g., horizontal). In some examples, the reflective polarizer may be adhered to a lens surface, such as the facets of a Fresnel lens or the curved outer surface of a meniscus lens.

In some examples, a reflective polarizer may include a cholesteric liquid crystal, such as a polymer cholesteric liquid crystal, or a solid layer having the optical properties of a cholesteric liquid crystal (e.g., a crosslinked or network stabilized CLC). In some examples, a reflective polarizer may include a birefringent multilayer reflective polarizer. In some examples, an apparatus may further include an optical retarder, such as a quarter wave retarder, located between the beamsplitter and the reflective polarizer.

Example reflective polarizers (or other polarizers) may include polarizing films. An example polarizing film may include one or more layers, such as an optical polarizer including a combination of a reflective polarizer and a dichroic polarizer, for example, bonded together.

In some examples, a polarizing beam splitter may include a transparent lens with a first and a second surface, where the first surface may be an adjustable lens (e.g., a fluid lens, a Fresnel lens, or other lens) and the second surface is adjacent to a reflective polarizing layer. At least one of the first and second surfaces may have a cylindrical, spherical, or aspherical curvature that may be controlled using an actuator.

In some examples, a reflector may include a reflective polarizer and/or a beamsplitter (e.g., a partial reflector). A partial reflector may include a coating that is partially reflective and partially transparent to at least one operational wavelength. In some examples, a reflector may change the handedness of reflected circularly polarized light. The reflector may include at least one thin uniform metallic coating, such as at least one of a thin silver or aluminum coating, a patterned metallic coating, a dielectric coating, other coating, or any combination thereof.

In some examples, a polarizer layer may include an arrangement of microparticles and/or nanoparticles in an optical material, such as a polymer matrix. Example optical materials may include one or more fluoropolymers (e.g., polymers of one or more monomer species such as tetrafluoroethylene, vinylidene fluoride, chlorotrifluoroethylene, perfluoroalkoxy compounds, fluorinated ethylene-propylene, ethylenetetrafluoroethylene, ethylenechlorotrifluoroethylene, perfluoropolyether, perfluoropolyoxethane, and/or hexafluoropropylene oxide).

Example polymers may include organosilicon compounds such as silicone polymers, including polymers of siloxane or silyl derivatives such as silyl halides. Polymers may also include polymers of one or more monomer species such as ethylene oxide, propylene oxide, carboxylic acid, acrylates such as acrylamide, amines, ethers, sulfonates, acrylic acid, vinyl alcohol, vinylpyridine, vinylpyrrolidone, acetylene, heterocyclic compounds such as pyrrole, thiophene, aniline, phenylene sulfide, imidazole, or other monomer species.

Particles may include one or more materials such as metals (e.g., transition metals, aluminum, alloys), metal oxides (e.g., transition metal oxides, magnesium oxide, aluminum oxide, zinc oxide, zirconium oxide, or transparent conductive oxides such as indium tin oxide, indium gallium zinc oxide, or antimony tin oxide), carbides, nitrides, borides, halides, fluoropolymers, carbonates (e.g., calcium carbonate), carbon allotropes (e.g., fullerenes or carbon nanotubes), and mixtures thereof. Examples also include glass particles, ceramic particles, silicates, or silica. Particles may include one or more polymers, including polymers described herein, such as poly(tetrafluoroethylene) particles. As used herein, particles may include microparticles, nanoparticles, spherical particles, rods, tubes, or other geometric or non-geometric shapes.

In some embodiments, an apparatus may include an optical configuration that includes a Fresnel lens assembly. A Fresnel lens assembly may include a reflective polarizer configured to reflect a first polarization of light and transmit a second polarization of light. For example, a reflective polarizer may reflect one handedness of circularly polarized light and transmit the other handedness of circularly polarized light. Example apparatus may include a beamsplitter lens or, in some examples, a second Fresnel lens assembly. A beamsplitter lens may include a beamsplitter formed as a coating on a lens.

Fresnel lens assemblies including a reflective polarizer may be used in augmented reality and/or virtual reality (AR/VR) systems. In some examples, a Fresnel lens assembly may include a Fresnel lens and at least one other optical component, such as one or more of a reflective polarizer, an optical filter, an absorbing polarizer, a diffractive element, an additional refractive element, a reflector, an antireflection film, a mechanically protective film (e.g., a scratch-resistant film), or other optical component. An apparatus including a Fresnel lens assembly may further include a display and a beamsplitter.

In some examples, an AR/VR system may include a Fresnel lens assembly including a Fresnel lens and a polarized reflector. The optical properties of the Fresnel lens may be determined individually, but in some examples, the properties of a reflective polarizer, filler layer, or other layer may be configured to improve the Fresnel lens performance (e.g., by reducing chromatic aberration). In some examples, a Fresnel lens may be concave, convex, or may have a complex optical profile such as a freeform surface. For example, the structured surface of a Fresnel lens may include facets corresponding to portions of a freeform lens optical surface, or of other lens surfaces such as other concave or convex surfaces. In particular embodiments, a Fresnel lens may be formed by 3D printing.

The wavelength-dependent properties of a Fresnel lens assembly, or polarized reflector, may be adjusted by, for example, controlling one or more parameters of a multilayer film configuration (e.g., individual layer refractive indices, optical dispersion, and/or layer thicknesses). In some examples, a reflective polarizer may have a particular bandwidth of operation and the bandwidth of operation may be adjusted using one or more parameters of one or more components (e.g., refractive index, optical dispersion, layer thickness, and the like).

Applications of Fresnel lens assemblies may include use in the optical configuration of a wearable device (e.g., a head-mounted device), for example, use of one or more Fresnel lens assemblies in an optical configuration adapted to form an image of a display viewable by a user when the user wears the wearable device. Other example applications may include IR (infra-red) rejection in, for example, imaging, display, projection, or photovoltaic systems. Applications may include wavelength selection for optical waveguides, for example, to select red, green, yellow, and/or blue wavelengths for transmission along a waveguide using a Fresnel lens assembly at the waveguide input. In some examples, a structured surface may be formed at the light entrance to any suitable optical component and configured as a Fresnel lens assembly.

A Fresnel lens assembly may include a Fresnel lens and a polarizer. For example, at least one facet of a Fresnel lens may support a reflective polarizer or absorptive polarizer. A Fresnel lens may include a plurality of facets and steps formed in an otherwise planar surface, a cylindrical surface, a freeform surface, a surface defined at least in part by a Zernike function, or a spherical surface. A Fresnel lens, including its facets and steps, may be formed by 3D printing. A Fresnel lens assembly may include additional components, such as a substrate, filler polymer layer, or any suitable optical element.

In some examples, a Fresnel lens assembly may include a Fresnel lens and a reflective polarizer. In some examples, the reflective polarizer may be supported by (e.g., deposited on, adhered to, or otherwise supported by) the facets of the Fresnel lens.

In some examples, a Fresnel lens assembly including a reflective polarizer may further include a filler layer. The filler layer may include an optically clear layer that is located on the structured surface of the Fresnel lens assembly. For example, a filler layer may conform to the facets and steps of a structured surface (e.g., of a Fresnel lens) and may have a second surface without facets or steps, for example, a generally smooth surface. For example, the filler layer may have a planar, concave or convex surface that may also be an exterior surface or support one or more additional layers, such as an antireflection layer or other optical layer. A reflective polarizer may be formed on a facet of a structured optical element, such as a Fresnel lens. In some examples, a reflective polarizer may include a multilayer reflective polarizer including at least one birefringent layer. In some examples, a reflective polarizer may include one or more polymer layers and/or one or more inorganic layers.

In some examples, a structured optical element may include a substrate having a surface including facets and steps, where the steps are located between neighboring (e.g., proximate or substantially adjacent) facets. A reflective polarizer may be located adjacent to and conforming to at least a portion of a faceted surface. In some examples, a faceted surface may correspond to a surface portion of a refractive lens, such as a convex or concave surface, and may be curved. In some examples, a facet may be planar and may approximate a surface portion of a refractive lens. For example, a planar faceted surface may have an orientation to the optic axis of the lens that varies with the average (e.g., mean) radial distance of the facet from the optical center of the lens. In this context, a structured optical element may include surface facets separated by steps, and at least one facet of a Fresnel lens may support a reflective polarizer. The filler material may then coat a surface of a Fresnel lens assembly (e.g., including facets, steps and the reflective polarizer). The filler layer may have a first surface having a profile that is complementary to the Fresnel lens assembly, and a second surface (e.g., an exterior surface) that may be a planar surface. In some examples, the second surface of the filler material may have a curved surface, such as a convex, concave, cylindrical, freeform, or other curved surface, or, in some examples, may include a second Fresnel lens structure.

In some examples, the steps between facets may have step heights and/or draft angles that may be a function of position within the optical element, for example, a function of radial distance from the optical center of a lens. In some examples, the gap between adjacent reflective polarizer segments may vary as a function of position within the optical element, such as a function of radial distance from the optical center of the lens. In some examples, a Fresnel lens assembly includes at least one Fresnel lens and is configured to reflect a first polarization of light and transmit a second polarization of light. The Fresnel lens assembly may include a reflective polarizing layer disposed on the facets of the structured surface of a Fresnel lens.

In some examples, a structured optical element (e.g., a Fresnel lens) may include a substrate having at least two adjacent facets that are separated by a step (sometimes referred to as a riser), where the facets have facet surfaces, and where a reflective polarizer layer is adjacent to and conforms to at least a portion of the facet surface of at least one of the facets.

In some examples, a lens may include an optical layer (e.g., a reflective polarizer, an absorbing polarizer, an optical retarder, an optical absorber or other optical layer) formed as a coating on a lens surface, such as one or more Fresnel lens facets. An optical layer may include a multilayer optical layer, a cholesteric liquid crystal or solid derived therefrom or having similar optical properties, or an anisotropic layer or a layer including anisotropic electrical conductors.

In some examples, a Fresnel lens may include a reflective polarizer formed as a layer on one or more of the lens facets. The reflective polarizer may include a multilayer optical film, cholesteric liquid crystal, or an arrangement of anisotropic conductors. The facets and coating may be embedded in an optically clear layer, such as a filler polymer. The refractive indices and optical dispersions of the Fresnel lens material and the filler polymer may be selected to reduce chromatic aberration (e.g., colored fringes in the image).

In some examples, optical materials (e.g., used in a Fresnel lens) may have a low birefringence (e.g., corresponding to less than a quarter wavelength optical retardance). In some examples, a Fresnel lens and/or filler polymer may include a silicone polymer such as polydimethylsiloxane (PDMS), cyclic olefin polymer (COP), cyclic olefin copolymer (COC), polyacrylate, polyurethane, or polycarbonate. For example, a PDMS Fresnel lens may be supported on a rigid substrate such as glass.

Vapor deposition of coatings may lead to unwanted deposition on the risers between facets. Appropriately sectioned coating layers may be selectively located on the facets of a Fresnel lens using an elastomeric substrate. Fresnel lens supported reflective polarizers may be used in augmented reality and/or virtual reality (AR/VR) systems. Other components may include a display and a beamsplitter. In some examples, an AR/VR system may include a Fresnel lens supported beamsplitter, and lenses may be optimized separately. Fresnel lenses may be concave, convex, or may have complex optical profiles such as freeform surfaces. Wavelength-dependent properties may be adjusted by, for example, adjusting multilayer film configurations.

In some examples, a Fresnel lens may include a flexible and/or elastic material (e.g., a silicone polymer such as PDMS) and may be formed on an actuator, such as a multilayer actuator. In some examples, an actuator may be located between a relatively rigid substrate (e.g., glass or an acrylate polymer) and an elastomer-based Fresnel lens structure. Electrical signals applied to the actuator may be used to control the slope of the facets of the Fresnel lens and hence the optical power of the Fresnel lens.

In some examples, the facets of a Fresnel lens and an optional optical layer formed thereon may be embedded in a filler layer such as an optically transparent filler polymer layer. For example, a filler layer may be formed supported by an assembly including the Fresnel lens and the polarizer. The filler layer may include an optically transparent polymer. The filler layer may have a structured surface complementary to the Fresnel lens and any other coating disposed thereon, and a second surface that may be generally smooth (e.g., planar, concave, or convex) or, in some examples, may be faceted to provide additional optical power (e.g., using a second Fresnel lens formed in the filler layer).

The refractive indices and optical dispersions of the Fresnel lens material and the filler polymer may be selected to reduce chromatic aberration (e.g., colored fringes in the image). Preferably, optical materials have low birefringence (e.g., less than one quarter wavelength optical retardance for at least one visible wavelength). An example Fresnel lens and/or optional filler polymer may include a silicone polymer such as polydimethylsiloxane (PDMS), cyclic olefin polymer (COP), cyclic olefin copolymer (COC), polyacrylate, polyurethane, or polycarbonate. For example, a PDMS Fresnel lens may be supported on a rigid substrate such as glass.

In some examples, a lens may have a polarizer, such as a reflective polarizer or absorptive polarizer, formed as a layer on at least one of the lens surfaces. The layer may include a multilayer optical film, cholesteric liquid crystal, or an arrangement of anisotropic conductors such as a nanowire arrangement. In some examples, the lens may be a Fresnel lens and the facets and any layer(s) may be embedded in a filler layer that may include an optically clear polymer. In some examples, a filler layer may planarize or otherwise smooth an exterior surface of a Fresnel lens assembly. The refractive indices and optical dispersions of the lens material and any additional layers may be configured to reduce chromatic aberration (e.g., to reduce visually discernable colored fringes in an image of the display). In some examples, the filler polymer may be configured as a second Fresnel lens, a geometric lens, and/or diffractive lens. For example, the filler polymer may have a first surface having facets forming an interface with the first Fresnel lens, and a second surface such as a non-faceted surface (e.g., a planar surface or a curved surface such as a concave, convex, aspheric or freeform surface) or a faceted surface. In some examples, the filler polymer may form a diffractive lens including diffractive elements on one or both surfaces. In some examples, a reflector or reflective polarizer may be located between the facets of the first Fresnel lens and the filler polymer.

Appropriately sectioned coating layers (e.g., at least partially reflective layers such as reflectors, beamsplitters, or reflective polarizers) may be selectively located on the facets of an optical element (e.g., a lens such as a Fresnel lens) using any suitable approach, for example, using an elastomeric substrate or other substrate to urge the coating layer against a surface of the optical element. Lens (e.g., Fresnel lens) supported reflective polarizers may be used in augmented reality and/or virtual reality (AR/VR) systems. Additional components may include a display and a beamsplitter.

In some examples, the reflective polarizer may be patterned to be in registration with the facets of the Fresnel lens. The patterned reflective polarizer may be formed on an elastomer element, aligned with the facets, and then the elastomer element may be moved (e.g., by an actuator) so that the patterned reflective polarizer is urged in contact with the facets of the Fresnel lens.

In some examples, an AR/VR system may include a Fresnel lens supported beamsplitter, and individual lenses may be designed separately. Fresnel lenses may be concave, convex, or may have complex optical profiles such as freeform surfaces. Wavelength-dependent properties may be adjusted by, for example, adjusting multilayer film configurations.

In some examples, an optical configuration may be used to introduce a phase delay into one or more polarization components of a light ray. Examples include quarter wave plates and half wave plates. In some examples, an optical retarder may be used to convert circular polarization into a linear polarization or vice versa.

In some examples, a reflective polarizer may include a cholesteric liquid crystal, such as a polymer (cross-linked) cholesteric liquid crystal. In some examples, the reflective polarizer may include a birefringent multilayer reflective polarizer combined with a quarter wave retarder placed between the reflective polarizer and a second reflector (e.g., a beamsplitter or other reflective polarizer).

A beamsplitter may be configured to reflect a first portion of incident light and transmit a second portion of incident light. In some examples, a beamsplitter lens may include a lens (e.g., a Fresnel lens or other lens) and a beamsplitter formed on at least a portion of a lens surface or, for example, at an interface between components of a lens assembly.

In some examples, a beamsplitter may be formed on the surface of a lens, such as on the facets of a Fresnel lens, using one or more of various approaches. For example, a beamsplitter may be formed on an elastic element and urged against the surface of an optical component such as a lens. A beamsplitter may be formed on a substrate and patterned to form portions sized to match the facets of a Fresnel lens.

An example reflective layer may include one or more metals such as aluminum or silver, and may be metallic. An example reflective layer may include one or more dielectric materials such as silica, aluminum oxide, hafnium oxide, titanium dioxide, magnesium oxide, magnesium fluoride, indium tin oxide, indium gallium zinc oxide, and the like, as well as combinations thereof. An example reflective layer may include one or more dielectric layers, and may include a Bragg grating structure or similar multilayer structure.

Reflective layers may be formed by one or a combination of processes including thin film physical vapor deposition, chemical vapor deposition, or other suitable processes for depositing reflective layers, such as highly and/or partially reflective thin film coatings.

An example beamsplitter may include one or more regions having different transmissivity and/or reflectance, and may include one or more reflective layers. An example beamsplitter may include first and second regions having a different reflectance, for example, for visible light or at least one visible wavelength of light. A beamsplitter may include a coating formed on a surface of the lens, such as a metal coating and/or a dielectric coating such as a dielectric multilayer. In some examples, the reflectance of a beamsplitter may vary as a function of spatial position within the beamsplitter. For example, a beamsplitter may include a first region having a first reflectance and a second region having a second reflectance. In some examples, a beamsplitter may have a higher reflectance toward the edges of the beamsplitter than within a central region of the beamsplitter.

An example beamsplitter may include a coating that is partially transparent and partially reflective. An example beamsplitter may include a thin coating including a metal such as gold, aluminum, or silver. A thin coating may have a coating thickness in the range of approximately 10 nm to approximately 500 nm. An example beamsplitter may include one or more layers, such as dielectric thin film layers. In some examples, a beamsplitter may include at least one dielectric material, for example, as a dielectric layer or component thereof, such as silica, aluminum oxide, hafnium oxide, titanium dioxide, magnesium oxide, magnesium fluoride, and the like. An example beamsplitter may include a coating including at least one thin metal coating and/or at least one dielectric coating. An example beamsplitter may include at least one of an electrically conductive material (e.g., a metal, an electrically conductive metal oxide such as indium tin oxide or indium gallium zinc oxide, or other conductive material) and a dielectric material, and may include a combination of an electrically conductive material and a dielectric material (e.g., as a coating including at least one layer).

In some examples, a beamsplitter may be formed on a convex, planar, or concave surface of a lens. The lens may be formed by 3D printing. In some examples, the lens may include a Fresnel lens. In some examples, a polarized reflector may be configured to function as a beamsplitter and may for example, be configured to reflect a first percentage of a first polarization of light and a second percentage of a second polarization of light, where the first and second percentages may be different, while transmitting some, most, or effectively all of the non-reflected light.

An example reflector (e.g., a beamsplitter, polarized reflector, or other reflector) may include at least a first and a second region, where the first region may include a central region of the reflector, and the second region may include an outer (peripheral) region of the reflector. In some examples, a reflector (e.g., a beamsplitter or a polarized reflector for a particular polarization) may have a reflectance of approximately 100%, approximately 95%, approximately 90%, approximately 85%, approximately 80%, approximately 75%, approximately 70%, or within a range between any two example values of these example reflectance values. The second region may have a reflectance between approximately 75% and approximately 100%, such as a reflectance between approximately 85% and approximately 100%. In some examples, the second region may have a higher reflectance than the first region, such as at least 10% higher reflectance.

In some examples, the relationship between reflectance and distance may be a monotonic smooth curve. In some examples, the relationship between reflectance and distance may be discontinuous or include transition regions with relatively high rates of change in reflectance. In some examples, there may be a gradual transition in reflectance of the beamsplitter from the first region to the second region within a transition region. The transition region may have a width (which may be termed a transition distance) that may be less than approximately 5 mm, such as less than 2 mm, such as less than 1 mm. In some examples, the transition region width may be less than 0.1 mm, such as less than 0.01 mm.

In some examples, a reflector (e.g., a beamsplitter or polarized reflector) may include a layer that is partially transparent and partially reflective. In some examples, a reflector may include a metal film formed on a substrate, such as a substrate including one or more optical materials. For example, the layer may include a metal layer (e.g., having a thickness between approximately 5 nm and approximately 500 nm, such as a thickness between 10 nm and 200 nm), such as a layer including one or more metals such as aluminum, silver, gold, or other metal such as an alloy. The layer may include a multilayer, and may include a corrosion protection layer supported by the exposed surface of the layer. In some examples, the layer may include one or more dielectric layers, such as dielectric thin film layers. Dielectric layers may include one or more dielectric layers such as oxide layers (e.g., metal oxide layers or other oxide layers), nitride layers, boride layers, phosphide layers, halide layers (e.g., metal halide layers such as metal fluoride layers), or other suitable layers. In some examples, the device may include one or more metal layers and/or one or more dielectric layers. A substrate may include glass or an optical polymer and may be rigid or mechanically compliant.

In some examples, an apparatus may include a display, at least one Fresnel lens assembly including a polarized reflector, and optionally a beamsplitter lens including a beamsplitter. The reflectance of the beamsplitter and/or the polarized reflector may vary as a function of spatial position, for example, including a first region of relatively high optical transmission and a second region of relatively low optical transmission (e.g., of relatively higher reflectance). In this context, a segmented reflector may have at least two regions having different optical properties, such as regions of different values of reflectance, for example, for one or more visible wavelengths.

In some examples, a device may include a reflector having a gradual or effectively discontinuous transition in the reflectance from a first region to a second region. A transition region may be located between the first region and the second region. As measured along a particular direction (e.g., a radial direction, normal to the periphery of the first region, or other direction) the transition region may extend over a transition distance between the first region and the second region. In some examples, the transition distance may have a length that is approximately or less than 5 mm, 1 mm, 0.1 mm, or 0.01 mm.

In some examples, a reflector may provide selective reflection over a particular wavelength range and/or for a particular polarization. For example, a reflector may include a Bragg reflector, and layer composition and/or dimensions may be configured to provide a desired bandwidth of operation.

In some examples, a reflector may be formed on an optical substrate such as a lens, and a combination of a lens and a reflector may be termed a reflector lens. A reflector lens may include an optical element having at least one curved surface. A reflector may include a reflective coating formed on or otherwise supported by a planar or a curved surface of an optical element such as a lens.

During fabrication of a reflector, different reflector regions having different values of optical reflectance may be defined by a masked deposition process or using photolithography, or a combination thereof.

In some examples, a lens (such as a Fresnel lens) may include a surface such as a concave surface, a convex surface or a planar surface. In some examples, a device may include one or more converging lenses and/or one or more diverging lenses. An optical configuration may include one or more lenses and may be configured to form an image of at least part of the display at an eyebox. A device may be configured so that an eye of a user is located within the eyebox when the device is worn by the user. In some examples, a lens may include a Fresnel lens having facets formed on a substrate including an optical material. In some examples, an optical configuration may include one or more reflectors, such as mirrors and/or reflectors.

In some examples, apparatus efficiency may be increased using a pancake lens including a beamsplitter that has higher reflectance toward the edges of the beamsplitter than within a central region of the beamsplitter. Lens efficiency may be increased using a polarization-converting beamsplitter lens including a beamsplitter that has higher reflectivity toward the edges of the lens than within a central region of the lens. In some examples, a pancake lens may include a refractive lens and a beamsplitter that may be formed as a reflective coating on a surface of the lens. The reflective coating may have a spatially varying reflectance. In some examples, a pancake lens may include a polarization-converting beamsplitter lens.

In some embodiments, an apparatus may include a display (e.g., a display panel) and a folded optic lens. Light from the display panel incident on the folded optic lens may be circularly polarized, linearly polarized, elliptically polarized or otherwise polarized. In some examples, the display may be an emissive display or may include a backlight. An emissive display may include a light-emitting diode (LED) array, such as an OLED (organic light-emitting diode) array. In some examples, an LED array may include a microLED array, and the LEDs may have a pitch of approximately or less than 100 micrometers (e.g., approximately or less than 50 micrometers, approximately or less than 20 micrometers, approximately or less than 10 micrometers, approximately or less than 5 micrometers, approximately or less than 2 micrometers, approximately or less than 1 micrometer, or other pitch value).

In some examples, the display may emit polarized light, such as linearly polarized light or circularly polarized light. In some examples, the display may emit linear polarized light and an optical retarder may be used to convert the linear polarization to an orthogonal linear polarization. In some examples, the combination of an optical retarder and a linear reflective polarizer may be replaced with an alternative configuration, such as a circularly polarized reflective polarizer which may include a cholesteric liquid crystal reflective polarizer.

In some examples, the display may include a transmissive display (such as a liquid crystal display) and a light source, such as a backlight. In some examples, the display may include a spatial light modulator and a light source. An example spatial light modulator may include a reflective or transmissive switchable liquid crystal array.

In some examples, an apparatus may include a display configured to provide polarized light, such as circularly polarized light. A display may include an emissive display (e.g., a light-emitting display) or a display (e.g., a liquid crystal display) used in combination with a backlight.

In some examples, display light from the display incident on the beamsplitter lens is circularly polarized. The display may include an emissive display (such as a light-emitting diode display) or a light-absorbing panel (such as a liquid crystal panel) in combination with a backlight. An emissive display may include at least one LED array, such as an organic LED (OLED) array. An LED array may include a microLED array. An LED array may include LEDs having a pitch of less than approximately 100 micrometers (e.g., approximately 50 micrometers, approximately 20 micrometers, approximately 10 micrometers, approximately 5 micrometers, approximately 2 micrometers, or approximately 1 micrometer, etc.).

In some examples, a display may include a spatial light modulator and a light source (e.g., a backlight). A spatial light modulator may include a reflective or transmissive switchable liquid crystal array. In some examples, the light source (e.g., a backlight) may have and/or allow a spatial variation of illumination intensity over the display. In some examples, the light source may include a scanned source such as a scanned laser. In some examples, the light source may include an arrangement of light emissive elements, such as an array of light emissive elements. An array of light emissive elements may include an array of miniLED and/or microLED emissive elements.

In some examples, a display may include one or more waveguide displays. A waveguide display may include a polychromatic display or an arrangement of monochromatic displays. A waveguide display may be configured to project display light from one or more waveguides into an optical configuration adapted to form an image of at least part of the display at the eye box.

In some examples, the display brightness may be spatially varied to increase the imaged display brightness uniformity by at least, for example, approximately 10%, for example, approximately 20%, for example, approximately 30%, for example, approximately 40%, or by some other value. The display illumination variation may be dynamically controlled, for example, by a controller. In some examples, the dynamic illumination variation may be adjusted by a controller receiving eye tracking signals provided by an eye tracking system.

In some examples, the display may have a spatially adjustable brightness (e.g., a spatial variation in illumination intensity). In some examples, the adjustable brightness may be achieved by spatially varying the brightness of an emissive display or of a backlight. The display brightness and/or any spatial variation may be adjustable, for example, by a control circuit. In some examples, the light source may include a scannable light source, such as a laser. In some examples, the light source may include an array of light sources, such as an LED backlight. For example, the array of light sources may include a miniLED or microLED array. The display illumination may be spatially varied to increase the imaged display brightness uniformity by at least approximately 10% (e.g., approximately 20%, approximately 30%, approximately 40%, or other value). The spatial variation of illumination from the backlight may be dynamically adjusted, and the dynamic adjustment may be controlled by an eye tracking system.

In some example, an apparatus may include one or more actuators. The one or more actuators may be used to adjust the position of an optical component along one or more translational or rotational directions. In some examples, at least one actuator may be used to adjust the optical power of a lens and/or to adjust the position, conformation, or other parameter of a first optical element relative to that of a second optical element or display.

In some examples, an actuator may include a piezoelectric actuator, for example, including a piezoelectric material such as a crystal or ceramic material. Example actuators may include an actuator material such as one or more of the following: lead magnesium niobium oxide, lead zinc niobium oxide, lead scandium tantalum oxide, lead lanthanum zirconium titanium oxide, barium titanium zirconium oxide, barium titanium tin oxide, lead magnesium titanium oxide, lead scandium niobium oxide, lead indium niobium oxide, lead indium tantalum oxide, lead iron niobium oxide, lead iron tantalum oxide, lead zinc tantalum oxide, lead iron tungsten oxide, barium strontium titanium oxide, barium zirconium oxide, bismuth magnesium niobium oxide, bismuth magnesium tantalum oxide, bismuth zinc niobium oxide, bismuth zinc tantalum oxide, lead ytterbium niobium oxide, lead ytterbium tantalum oxide, strontium titanium oxide, bismuth titanium oxide, calcium titanium oxide, lead magnesium niobium titanium oxide, lead magnesium niobium titanium zirconium oxide, lead zinc niobium titanium oxide, lead zinc niobium titanium zirconium oxide as well as any of the previous mixed with any of the previous and/or ferroelectrics including lead titanium oxide, lead zirconium titanium oxide, barium titanium oxide, bismuth iron oxide, sodium bismuth titanium oxide, lithium tantalum oxide, sodium potassium niobium oxide, and lithium niobium oxide. An actuator layer may include lead titanate, lead zirconate, lead zirconate titanate, lead magnesium niobate, lead magnesium niobate-lead titanate, lead zinc niobate, lead zinc niobate-lead titanate, lead magnesium tantalate, lead indium niobate, lead indium tantalate, barium titanate, lithium niobate, potassium niobate, sodium potassium niobate, bismuth sodium titanate, or bismuth ferrite. One or more of the above-listed example actuator materials may also be used as an optical material, a layer (e.g., of an optical component) or a substrate material (e.g., as a substrate for a beamsplitter). In some examples, an actuator may be configured to adjust the position and/or conformation of an optical element, such as a lens.

The following will provide, with reference to FIGS. 1-15, detailed descriptions of methods for optical system manufacture and associated pancake lens architectures. The discussion associated with FIGS. 1-10 includes a description of methods of forming a meniscus lens and hybrid lens designs. The discussion associated with FIGS. 11-13 includes a description of carrier film material specifications. The discussion associated with FIGS. 14 and 15 relate to exemplary virtual reality and augmented reality devices that may include one or more 3D printed pancake lenses as disclosed herein.

Applicants have shown that 3D printing may be used to provide lens architectures having improved image quality in a wearable form factor, e.g., having a smaller sized display. Turning to FIG. 1, shown schematically is an example 3D printing method 100 for manufacturing a meniscus lens.

In the illustrated method, a resinous source material may be heated and expelled as droplets through the nozzle of a printer head. The droplets may alight on the curved surface of a substrate and accumulate to form a meniscus lens. According to some embodiments, an average droplet size may be at least approximately 500 nm, and during formation of the lens a minimum distance between the printer head and the substrate or over-layer of deposited material may be at least approximately 5 mm.

Turning to FIG. 2, shown schematically is an example hybrid method 200 for manufacturing a meniscus lens. The hybrid method 200 may include sequential acts of casting/molding 210 and 3D printing 220.

During casting/molding 210, a first resinous material may be injected between front and back molds to form a lens template therebetween. The lens template may be cured before or after removing the lens template from the mold in order to stabilize the lens template, which may define a general form factor for the lens.

Subsequently, during 3D printing 220, a second resinous source material may be heated and expelled as droplets through the nozzle of a printer head 224 such that the droplets may alight on a surface of the lens template and accumulate to form a hybrid meniscus lens. The printing step may be configured to manipulate and tune the optical properties of the resulting hybrid structure.

Details of the 3D printing process 300 are shown schematically in FIG. 3. According to some embodiments, an average droplet size during the act of printing may be at least approximately 500 nm, and during printing a minimum distance between the printer head 324 and the lens template may be at least approximately 5 mm.

Referring to FIG. 4, shown is a schematic view of an example lamination apparatus 400 and an associated method for forming a pancake optic. In the illustration, a non-planar pancake lens substrate may be held between first and second chambers of the apparatus and a lamination architecture including a sized multilayer optical film, an adhesive/release layer, and an oversized carrier film may be aligned with and brought into proximity with a curved surface of the substrate. Optionally in conjunction with applied heat, a pressure differential may be applied across the lamination architecture in an amount effective to urge the multilayer optical film into contact with the lens surface. Following lamination, the adhesive/release layer and the carrier film may be removed from the overcoated lens. For example, the adhesive/release layer may be peeled away from the laminated multilayer optical film.

In examples where the lens substrate is heated during lamination, a temperature gradient across the substrate and across the lamination architecture may be advantageously less than approximately 10° C., e.g., less than 10° C., less than 5° C., less than 2° C., or less than 1° C., including ranges between any of the foregoing values. In comparative processes, a temperature gradient across an area of the lens substrate may be 20° C. or more.

The optical characterization of a printed meniscus lens 500 is provided in FIG. 5. FIG. 6 is an optical micrograph of an example 3D printed lens 600. Referring to FIG. 7, shown is a cross-sectional view of an example pancake lens architecture 700 including a pair of printed meniscus lenses. Referring to FIG. 8, shown is a cross-sectional view of a further example pancake lens architecture 800 including a pair of printed meniscus lenses.

Referring to FIG. 9, shown is a cross-sectional schematic illustration of example multilayer optical films 900. In some embodiments, a multilayer optical film may include, from top to bottom, a quarter wave plate, a reflective linear polarizer, an absorptive linear polarizer, an optional further quarter wave plate, and an anti-reflective coating. The foregoing architecture may be laminated via an optically clear adhesive layer to a pancake lens substrate (e.g., pancake lens 1) using an oversized carrier layer (not shown).

According to further embodiments, the anti-reflective coating may be omitted from the above-mentioned multilayer optical film and the multilayer optical film may be laminated to a second pancake lens substrate (e.g., pancake lens 2) via a second optically clear adhesive layer.

Referring to FIG. 10, shown is a cross-sectional schematic illustration of further example multilayer optical films 1000. In some embodiments, a multilayer optical film may include, from top to bottom, a reflective circular polarizer, a quarter wave plate, an absorptive linear polarizer, an optional additional quarter wave plate, and an anti-reflective coating. The foregoing architecture may be laminated via an optically clear adhesive layer to a pancake lens substrate using an oversized carrier layer (not shown).

According to still further embodiments, the anti-reflective coating may be omitted from the above-mentioned multilayer optical film and the multilayer optical film may be laminated to a second pancake lens substrate via a second optically clear adhesive layer. Key performance indicators (KPIs) for the pancake lens architectures of FIGS. 7 and 8 are summarized in the table 1100 of FIG. 11.

Referring to FIG. 12, tabulated are material specifications 1200 for suitable carrier films. Referring to FIG. 13, shown are material specifications 1300 for suitable adhesive/release layers. The choice of carrier layer and adhesive/release layer may influence the mechanical as well as the optical properties of the laminated pancake optic. For instance, a carrier film may be configured such that when formed into a lamination architecture, the lamination architecture during the act of lamination is substantially mechanically isotropic in-plane. According to some embodiments, the disclosed materials may be chosen to form a laminated pancake optic having one or more of (a) good cosmetic appearance that is free or substantially free of tears or wrinkles, (b) uniform polarization optics, and (c) low surface forming error, exhibiting low optical distortion.

Disclosed are shell pancake lenses and related methods for their manufacture. Example lenses may have an ultra-thin profile and a high aspect ratio and may be characterized as light weight having smooth surfaces and exhibiting a large variation in total thickness. The lenses may be configured as positive meniscus lenses or negative meniscus lenses, for instance, and may be formed directly over a suitably shaped (non-planar) substrate or mold.

A 3D printing process may be used to form polymeric meniscus lenses not otherwise manufacturable by comparative methods such as injection molding or casting. The 3D printing process may incorporate a pixel-type printer head that is adapted to provide precise control of resin droplet size and droplet size distribution over a defined area. The radius of curvature of an example lens may be less than approximately 80 mm.

Printed lenses may exhibit high quality surfaces, including roughness (RMS and PV), waviness, and orange peel, which may beneficially impact image quality metrics such as pupil swim and image distortion. The disclosed 3D printed meniscus lenses may be incorporated into the viewing optics of AR/VR glasses and headsets.

A method of lens manufacture includes distinct and successive forming steps that respectively leverage casting/molding and 3D printing technologies to create, for example, the viewing optics for AR/VR devices and headsets. In a first step, a casting/molding process may be utilized to create a generalized form factor for the lens. The lens preform may be cast from a suitable resin within a diamond turned glass mold, for example. In a subsequent step, one or more over-formed resin layers may be printed to tailor the final shape of the lens and accordingly define its optical properties including optical power, optical axis alignment, and axis-specific cylindricity.

The presently-disclosed hybrid approach may significantly decrease cycle time and associated costs of manufacture. Moreover, the disclosed hybrid lenses may exhibit structures and properties that are not accessible using casting/molding methods alone. According to certain embodiments, the separate acts of casting/molding and printing may incorporate equivalent or distinct resin compositions. Between the acts of casting/molding and printing, one or more additional layers may be incorporated into the lens architecture, including a buffer layer, an adhesion-promoting layer, an antireflective coating, etc.

Prior to printing, the cast/molded preform may be cured to stabilize its structure. Printed layers may be subsequently formed over one or both sides of the lens. In architectures that include multiple successively printed layers, each layer may be individually cured and stabilized throughout a progression of plural print steps that may terminate with curing of the accumulated structure. The disclosed hybrid lenses may be incorporated into the viewing optics of AR/VR glasses and headsets.

Disclosed are methods for laminating a multilayer optical film to a curved substrate such as a lens. A lamination architecture may include a sized multilayer optical film and an adhesive/release layer that are co-integrated with an oversized carrier film. Through the application of pressure (i.e., gas pressure) to the carrier film, the multilayer optical film may be formed over a non-planar surface of a lens followed by removal of the carrier film and the adhesive/release layer.

In some embodiments, the multilayer optical film may be configured to introduce functionality such as polarization optics, retardation, antireflection, or diffractive optics. The improvement in raw material utilization associated with using a sized multilayer optical film may significantly benefit the economics of manufacture. Moreover, relative to direct lamination of an oversized multilayer optical film, the implementation of an oversized carrier film may improve in the resulting lens one or more attributes including cosmetic appearance, polarization uniformity, and surface forming error especially with respect to decreasing surface roughness.

### EXAMPLE EMBODIMENTS

Example 1: A method includes providing an optical lens substrate having a non-planar deposition surface and depositing a resinous layer over the deposition surface to form a meniscus lens.

Example 2: The method of Example 1, where the depositing includes ink jet printing.

Example 3: The method of any of Examples 1 and 2, where during the depositing an average droplet size of a resinous compound forming the resinous layer is at least approximately 500 nm.

Example 4: The method of any of Examples 1-3, where a distance between a printer head and the deposition surface during the depositing is at least approximately 5 mm.

Example 5: The method of any of Examples 1-4, where the resinous layer includes an optically transparent compound.

Example 6: The method of any of Examples 1-5, where the resinous layer includes a UV curable compound.

Example 7: The method of any of Examples 1-6, where a surface of the meniscus lens proximate to the substrate includes concave curvature and a surface of the meniscus lens opposite to the substrate includes convex curvature.

Example 8: The method of any of Examples 1-6, where a surface of the meniscus lens proximate to the substrate includes a convex curvature and a surface of the meniscus lens opposite to the substrate includes concave curvature.

Example 9: The method of any of Examples 1-8, where the meniscus lens is a converging lens.

Example 10: The method of any of Examples 1-8, where the meniscus lens is a diverging lens.

Example 11: The method of any of Examples 1-10, further including irradiating, for curing, the resinous layer.

Example 12: The method of any of Examples 1-11, further including separating the meniscus lens from the deposition surface.

Example 13: A meniscus lens includes a resinous compound and further includes a radius of curvature of less than approximately 80 mm, sag of from approximately 2 mm to approximately 20 mm, and a maximum thickness of less than approximately 40 mm.

Example 14: The meniscus lens of Example 13, including a first surface having a first radius of curvature less than approximately 80 mm and a second surface having a second radius of curvature less than approximately 80 mm, where the first radius of curvature is unequal to the second radius of curvature.

Example 15: The meniscus lens of any of Examples 13 and 14, including a minimum thickness variation of at least approximately 2 mm.

Example 16: The meniscus lens of any of Examples 13-15, where the meniscus lens is a converging lens.

Example 17: The meniscus lens of any of Examples 13-15, where the meniscus lens is a diverging lens.

Example 18: The meniscus lens of any of Examples 13-17, including an optical transmissivity within the visible spectrum of at least approximately 90% and less than approximately 10% bulk haze.

Example 19: A 3D printed meniscus lens includes a radius of curvature of less than approximately 80 mm, sag of from approximately 2 mm to approximately 20 mm, a maximum thickness of less than approximately 40 mm, and a minimum thickness variation of at least approximately 2 mm.

Example 20: The 3D printed meniscus lens of Example 19, including a first surface having a first radius of curvature less than approximately 80 mm, and a second surface having a second radius of curvature less than approximately 80 mm, where the first radius of curvature is unequal to the second radius of curvature.

Example 21: A method includes introducing a first resin composition into a mold, curing the first resin composition to form a lens template, depositing a layer of a second resin composition over a surface of the lens template to form a modified lens template, and curing the layer of the second resin composition to form a hybrid lens.

Example 22: The method of Example 21, where the first and second resin compositions are substantially equivalent.

Example 23: The method of any of Examples 21 and 22, where the first and second resin compositions each include an optically transparent compound.

Example 24: The method of any of Examples 21-23, where the first and second resin compositions each include a UV curable compound.

Example 25: The method of any of Examples 21-24, where the mold is a diamond turned glass mold.

Example 26: The method of any of Examples 21-25, where depositing the layer of the second resin composition includes 3D printing.

Example 27: The method of Example 26, where during the depositing an average droplet size of the second resin composition is at least approximately 500 nm.

Example 28: The method of any of Examples 26 and 27, where a distance between a printer head and the surface of the lens template during the depositing is at least approximately 5 mm.

Example 29: The method of any of Examples 21-28, where depositing the layer of the second resin composition includes alternately depositing and curing two or more sub-layers.

Example 30: The method of any of Examples 21-29, where the layer of the second resin composition is configured to change a cylindrical optical power or a spherical optical power of the lens template.

Example 31: The method of any of Examples 21-30, where the layer of the second resin composition is configured to change a cylindrical optical power and a spherical optical power of the lens template.

Example 32: The method of any of Examples 21-31, where the layer of the second resin composition is configured to change an optical axis of the lens template.

Example 33: The method of any of Examples 21-32, further including irradiating, for curing, the hybrid lens.

Example 34: The method of any of Examples 21-33, where the hybrid lens includes a converging meniscus lens.

Example 35: The method of any of Examples 21-33, where the hybrid lens includes a diverging meniscus lens.

Example 36: A hybrid meniscus lens includes a cast resin core and a printed resin overlayer and further includes (a) a radius of curvature of less than approximately 80 mm, (b) sag of from approximately 2 mm to approximately 20 mm, and (c) a maximum thickness of less than approximately 40 mm.

Example 37: The hybrid meniscus lens of Example 36, including (d) a first surface having a first radius of curvature less than approximately 80 mm, and (e) a second surface having a second radius of curvature less than approximately 80 mm, where the first radius of curvature is unequal to the second radius of curvature.

Example 38: The hybrid meniscus lens of any of Examples 36 and 37, including a minimum thickness variation of at least approximately 2 mm.

Example 39: The hybrid meniscus lens of any of Examples 36-38, where the meniscus lens includes a converging lens.

Example 40: The hybrid meniscus lens of any of Examples 36-38, where the meniscus lens includes a diverging lens.

Example 41: The hybrid meniscus lens of any of Examples 36-40, having an optical transmissivity within the visible spectrum of at least approximately 90% and less than approximately 10% bulk haze.

Example 42: A hybrid meniscus lens includes (a) a radius of curvature of less than approximately 80 mm, (b) sag of from approximately 2 mm to approximately 20 mm, (c) a maximum thickness of less than approximately 40 mm, and (d) a minimum thickness variation of at least approximately 2 mm.

Example 43: The hybrid meniscus lens of Example 42, including (e) a first surface having a first radius of curvature less than approximately 80 mm, and (f) a second surface having a second radius of curvature less than approximately 80 mm, where the first radius of curvature is unequal to the second radius of curvature.

Example 44: A method includes forming a lamination architecture having a carrier film and a multilayer optical film overlying a portion of the carrier film, and forming a laminated pancake optic by contacting a surface of the multilayer optical film with a surface of a transparent non-planar substrate.

Example 45: The method of Example 44, where the carrier film extends beyond an entire peripheral edge of the multilayer optical film prior to forming the laminated pancake optic.

Example 46: The method of any of Examples 44 and 45, where the carrier film extends beyond an entire peripheral edge of the multilayer optical film while forming the laminated pancake optic.

Example 47: The method of any of Examples 44-46, where an area of the carrier film is greater than an area of the transparent non-planar substrate.

Example 48: The method of any of Examples 44-47, where the carrier film has a thickness of from approximately 0.01 mm to approximately 1 mm.

Example 49: The method of any of Examples 44-48, where the carrier film has an elastic modulus of from approximately 100 MPa to approximately 1500 MPa while forming the laminated pancake optic.

Example 50: The method of any of Examples 44-49, where the carrier film has a Poisson's ratio of from approximately 0.3 to approximately 0.5 while forming the laminated pancake optic.

Example 51: The method of any of Examples 44-50, where the carrier film has a tensile stress of from approximately 1 MPa to approximately 100 MPa while forming the laminated pancake optic.

Example 52: The method of any of Examples 44-51, where an elastic modulus of the carrier film has an in-plane anisotropy of from approximately 0.5 to approximately 2 while forming the laminated pancake optic.

Example 53: The method of any of Examples 44-52, where the multilayer optical film includes a quarter wave plate, a reflective linear polarizer, and an absorptive linear polarizer.

Example 54: The method of any of Examples 44-53, where the multilayer optical film includes a reflective linear polarizer located between a quarter wave plate and an absorptive linear polarizer.

Example 55: The method of any of Examples 44-53, where the multilayer optical film includes a reflective circular polarizer, a quarter wave plate, and an absorptive linear polarizer.

Example 56: The method of any of Examples 44-53, where the multilayer optical film includes a quarter wave plate located between a reflective circular polarizer and an absorptive linear polarizer.

Example 57: The method of any of Examples 44-56, where contacting the surface of the multilayer optical film with the non-planar surface of the transparent non-planar substrate includes applying pressure to the carrier film opposite to the multilayer optical film.

Example 58: The method of any of Examples 44-57, where the lamination architecture further includes an adhesive/release layer located between the carrier film and the multilayer optical film.

Example 59: The method of any of Examples 44-58, where a ratio of a radius of curvature of the laminated pancake optic to a diameter of the transparent non-planar substrate is less than approximately 4.

Example 60: The method of any of Examples 44-59, where the transparent non-planar substrate includes a lens.

Example 61: A method includes affixing a transparent non-planar substrate within a lamination apparatus between a first chamber and a second chamber, forming a lamination architecture within the first chamber overlying a surface of the transparent non-planar substrate, wherein the lamination architecture includes a carrier film having an area greater than an area of the transparent non-planar substrate and a multilayer optical film having an area substantially equal to the area of the transparent non-planar substrate, and applying pressure to the lamination architecture within the first chamber to urge the multilayer optical film into contact with the surface of the transparent non-planar substrate.

Example 62: The method of Example 61, where applying pressure to the lamination architecture within the first chamber includes increasing a gas pressure within the first chamber.

Example 63: A lamination architecture includes a carrier film and a multilayer optical film overlying an interior portion of the carrier film.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 1400 in FIG. 14) or that visually immerses a user in an artificial reality (e.g., virtual-reality system 1500 in FIG. 15). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 14, augmented-reality system 1400 may include an eyewear device 1402 with a frame 1410 configured to hold a left display device 1415(A) and a right display device 1415(B) in front of a user's eyes. Display devices 1415(A) and 1415(B) may act together or independently to present an image or series of images to a user. While augmented-reality system 1400 includes two displays, embodiments of this disclosure may be implemented in augmented-reality systems with a single NED or more than two NEDs.

In some embodiments, augmented-reality system 1400 may include one or more sensors, such as sensor 1440. Sensor 1440 may generate measurement signals in response to motion of augmented-reality system 1400 and may be located on substantially any portion of frame 1410. Sensor 1440 may represent a position sensor, an inertial measurement unit (IMU), a depth camera assembly, a structured light emitter and/or detector, or any combination thereof. In some embodiments, augmented-reality system 1400 may or may not include sensor 1440 or may include more than one sensor. In embodiments in which sensor 1440 includes an IMU, the IMU may generate calibration data based on measurement signals from sensor 1440. Examples of sensor 1440 may include, without limitation, accelerometers, gyroscopes, magnetometers, other suitable types of sensors that detect motion, sensors used for error correction of the IMU, or some combination thereof.

Augmented-reality system 1400 may also include a microphone array with a plurality of acoustic transducers 1420(A)-1420(J), referred to collectively as acoustic transducers 1420. Acoustic transducers 1420 may be transducers that detect air pressure variations induced by sound waves. Each acoustic transducer 1420 may be configured to detect sound and convert the detected sound into an electronic format (e.g., an analog or digital format). The microphone array in FIG. 14 may include, for example, ten acoustic transducers: 1420(A) and 1420(B), which may be designed to be placed inside a corresponding ear of the user, acoustic transducers 1420(C), 1420(D), 1420(E), 1420(F), 1420(G), and 1420(H), which may be positioned at various locations on frame 1410, and/or acoustic transducers 1420(I) and 1420(J), which may be positioned on a neckband 1405.

In some embodiments, one or more of acoustic transducers 1420(A)-(F) may be used as output transducers (e.g., speakers). For example, acoustic transducers 1420(A) and/or 1420(B) may be earbuds or any other suitable type of headphone or speaker.

The configuration of acoustic transducers 1420 of the microphone array may vary. While augmented-reality system 1400 is shown in FIG. 14 as having ten acoustic transducers 1420, the number of acoustic transducers 1420 may be greater or less than ten. In some embodiments, using higher numbers of acoustic transducers 1420 may increase the amount of audio information collected and/or the sensitivity and accuracy of the audio information. In contrast, using a lower number of acoustic transducers 1420 may decrease the computing power required by an associated controller 1450 to process the collected audio information. In addition, the position of each acoustic transducer 1420 of the microphone array may vary. For example, the position of an acoustic transducer 1420 may include a defined position on the user, a defined coordinate on frame 1410, an orientation associated with each acoustic transducer 1420, or some combination thereof.

Acoustic transducers 1420(A) and 1420(B) may be positioned on different parts of the user's ear, such as behind the pinna, behind the tragus, and/or within the auricle or fossa. Or, there may be additional acoustic transducers 1420 on or surrounding the ear in addition to acoustic transducers 1420 inside the ear canal. Having an acoustic transducer 1420 positioned next to an ear canal of a user may enable the microphone array to collect information on how sounds arrive at the ear canal. By positioning at least two of acoustic transducers 1420 on either side of a user's head (e.g., as binaural microphones), augmented-reality system 1400 may 1400 may simulate binaural hearing and capture a 3D stereo sound field about around a user's head. In some embodiments, acoustic transducers 1420(A) and 1420(B) may be connected to augmented-reality system 1400 via a wired connection (not shown), and in other embodiments acoustic transducers 1420(A) and 1420(B) may be connected to augmented-reality system 1400 via a wireless connection (e.g., a Bluetooth connection). In still other embodiments, acoustic transducers 1420(A) and 1420(B) may not be used at all in conjunction with augmented-reality system 1400.

Acoustic transducers 1420 on frame 1410 may be positioned along the length of the temples, across the bridge, above or below display devices 1415(A) and 1415(B), or some combination thereof. Acoustic transducers 1420 may be oriented such that the microphone array is able to detect sounds in a wide range of directions surrounding the user wearing the augmented-reality system 1400. In some embodiments, an optimization process may be performed during manufacturing of augmented-reality system 1400 to determine relative positioning of each acoustic transducer 1420 in the microphone array.

In some examples, augmented-reality system 1400 may include or be connected to an external device (e.g., a paired device), such as neckband 1405. Neckband 1405 generally represents any type or form of paired device. Thus, the following discussion of neckband 1405 may also apply to various other paired devices, such as charging cases, smart watches, smart phones, wrist bands, other wearable devices, hand-held controllers, tablet computers, laptop computers, other external compute devices, etc.

As shown, neckband 1405 may be coupled to eyewear device 1402 via one or more connectors. The connectors may be wired or wireless and may include electrical and/or non-electrical (e.g., structural) components. In some cases, eyewear device 1402 and neckband 1405 may operate independently without any wired or wireless connection between them. While FIG. 14 illustrates the components of eyewear device 1402 and neckband 1405 in example locations on eyewear device 1402 and neckband 1405, the components may be located elsewhere and/or distributed differently on eyewear device 1402 and/or neckband 1405. In some embodiments, the components of eyewear device 1402 and neckband 1405 may be located on one or more additional peripheral devices paired with eyewear device 1402, neckband 1405, or some combination thereof.

Pairing external devices, such as neckband 1405, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1400 may be provided by a paired device or shared between a paired device and an eyewear device, thus reducing the weight, heat profile, and form factor of the eyewear device overall while still retaining desired functionality. For example, neckband 1405 may allow components that would otherwise be included on an eyewear device to be included in neckband 1405 since users may tolerate a heavier weight load on their shoulders than they would tolerate on their heads. Neckband 1405 may also have a larger surface area over which to diffuse and disperse heat to the ambient environment. Thus, neckband 1405 may allow for greater battery and computation capacity than might otherwise have been possible on a stand-alone eyewear device. Since weight carried in neckband 1405 may be less invasive to a user than weight carried in eyewear device 1402, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1405 may be communicatively coupled with eyewear device 1402 and/or to other devices. These other devices may provide certain functions (e.g., tracking, localizing, depth mapping, processing, storage, etc.) to augmented-reality system 1400. In the embodiment of FIG. 14, neckband 1405 may include two acoustic transducers (e.g., 1420(I) and 1420(J)) that are part of the microphone array (or potentially form their own microphone subarray). Neckband 1405 may also include a controller 1425 and a power source 1435.

Acoustic transducers 1420(I) and 1420(J) of neckband 1405 may be configured to detect sound and convert the detected sound into an electronic format (analog or digital). In the embodiment of FIG. 14, acoustic transducers 1420(I) and 1420(J) may be positioned on neckband 1405, thereby increasing the distance between the neckband acoustic transducers 1420(I) and 1420(J) and other acoustic transducers 1420 positioned on eyewear device 1402. In some cases, increasing the distance between acoustic transducers 1420 of the microphone array may improve the accuracy of beamforming performed via the microphone array. For example, if a sound is detected by acoustic transducers 1420(C) and 1420(D) and the distance between acoustic transducers 1420(C) and 1420(D) is greater than, e.g., the distance between acoustic transducers 1420(D) and 1420(E), the determined source location of the detected sound may be more accurate than if the sound had been detected by acoustic transducers 1420(D) and 1420(E).

Controller 1425 of neckband 1405 may process information generated by the sensors on neckband 1405 and/or augmented-reality system 1400. For example, controller 1425 may process information from the microphone array that describes sounds detected by the microphone array. For each detected sound, controller 1425 may perform a direction-of-arrival (DOA) estimation to estimate a direction from which the detected sound arrived at the microphone array. As the microphone array detects sounds, controller 1425 may populate an audio data set with the information. In embodiments in which augmented-reality system 1400 includes an inertial measurement unit, controller 1425 may compute all inertial and spatial calculations from the IMU located on eyewear device 1402. A connector may convey information between augmented-reality system 1400 and neckband 1405 and between augmented-reality system 1400 and controller 1425. The information may be in the form of optical data, electrical data, wireless data, or any other transmittable data form. Moving the processing of information generated by augmented-reality system 1400 to neckband 1405 may reduce weight and heat in eyewear device 1402, making it more comfortable to the user.

Power source 1435 in neckband 1405 may provide power to eyewear device 1402 and/or to neckband 1405. Power source 1435 may include, without limitation, lithium ion batteries, lithium-polymer batteries, primary lithium batteries, alkaline batteries, or any other form of power storage. In some cases, power source 1435 may be a wired power source. Including power source 1435 on neckband 1405 instead of on eyewear device 1402 may help better distribute the weight and heat generated by power source 1435.

As noted, some artificial-reality systems may instead of blending an artificial reality with actual reality, substantially replace one or more of a user's sensory perceptions of the real world with a virtual experience. One example of this type of system is a head-worn display system, such as virtual-reality system 1500 in FIG. 15, that mostly or completely covers a user's field of view. Virtual-reality system 1500 may include a front rigid body 1502 and a band 1504 shaped to fit around a user's head. Virtual-reality system 1500 may also include output audio transducers 1506(A) and 1506(B). Furthermore, while not shown in FIG. 15, front rigid body 1502 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 1400 and/or virtual-reality system 1500 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 1400 and/or virtual-reality system 1500 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 1400 and/or virtual-reality system 1500 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 15, output audio transducers 1506(A) and 1506(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 14, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may in certain embodiments, mean and include the stated value as well as all values within 10% of the stated value. Thus, by way of example, reference to the numeric value “50” as “approximately 50” may in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a printed meniscus lens that comprises or includes a UV curable resin include embodiments where a printed meniscus lens consists essentially of a UV curable resin and embodiments where a printed meniscus lens consists of a UV curable resin.

What is claimed is:

1. A method comprising:
providing an optical lens substrate having a non-planar deposition surface;
depositing a resinous layer over the deposition surface to form a meniscus lens introducing a first resin composition into a mold;
curing the first resin composition to form a lens template;
depositing a layer of a second resin composition over a surface of the lens template to form a modified lens template;
curing the layer of the second resin composition to form a hybrid lens;
forming a lamination architecture comprising a carrier film and a multilayer optical film overlying a portion of the carrier film; and
forming a laminated pancake optic by contacting a surface of the multilayer optical film with a surface of a transparent non-planar substrate.

2. The method of claim 1, wherein the depositing comprises ink jet printing.

3. The method of claim 1, wherein during the depositing an average droplet size of a resinous compound forming the resinous layer is at least approximately 500 nm.

4. The method of claim 1, wherein a distance between a printer head and the deposition surface during the depositing is at least approximately 5 mm.

5. The method of claim 1, wherein the resinous layer comprises an optically transparent compound.

6. The method of claim 1, wherein the resinous layer comprises a UV curable compound.

7. The method of claim 1, wherein a surface of the meniscus lens proximate to the substrate comprises concave curvature and a surface of the meniscus lens opposite to the substrate comprises convex curvature.

8. The method of claim 1, wherein a surface of the meniscus lens proximate to the substrate comprises a convex curvature and a surface of the meniscus lens opposite to the substrate comprises concave curvature.

9. The method of claim 1, wherein the meniscus lens comprises a converging lens.

10. The method of claim 1, wherein the meniscus lens comprises a diverging lens.

11. The method of claim 1, further comprising irradiating, for curing, the resinous layer.

12. The method of claim 1, further comprising separating the meniscus lens from the deposition surface.

13. A meniscus lens comprising a resinous compound and further comprising:
a radius of curvature of less than approximately 80 mm;
sag of from approximately 2 mm to approximately 20 mm; and
a maximum thickness of less than approximately 40 mm.

14. The meniscus lens of claim 13, comprising:
a first surface having a first radius of curvature less than approximately 80 mm; and
a second surface having a second radius of curvature less than approximately 80 mm, wherein the first radius of curvature is unequal to the second radius of curvature.

15. The meniscus lens of claim 13, comprising a minimum thickness variation of at least approximately 2 mm.

16. The meniscus lens of claim 13, wherein the meniscus lens comprises a converging lens.

17. The meniscus lens of claim 13, wherein the meniscus lens comprises a diverging lens.

18. The meniscus lens of claim 13, comprising an optical transmissivity within a visible spectrum of at least approximately 90% and less than approximately 10% bulk haze.

19. A 3D printed meniscus lens comprising:
a radius of curvature of less than approximately 80 mm;
sag of from approximately 2 mm to approximately 20 mm;
a maximum thickness of less than approximately 40 mm; and
a minimum thickness variation of at least approximately 2 mm.

20. The 3D printed meniscus lens of claim 19, comprising:
a first surface having a first radius of curvature less than approximately 80 mm; and
a second surface having a second radius of curvature less than approximately 80 mm, wherein the first radius of curvature is unequal to the second radius of curvature.
